(19) United States
(12) Patent Application Publication
(10) Pub. No.: US 2018/0241870 A1
(43) Pub. Date: Aug. 23, 2018

(54) METHOD AND ELECTRONIC DEVICE FOR MANAGING INFORMATION OF APPLICATION

(71) Applicant: Samsung Electronics Co., Ltd., Gyeonggi-do (KR)

(72) Inventors: Debayan MUKHERJEE, Bengaluru (IN); Saumitri CHOUDHURY, Bengaluru (IN); Preksha SHUKLA, Bengaluru (IN); Prabhashish SINGH, Bengaluru (IN); Swadha JAISWAL, Bengaluru (IN)

(21) Appl. No.: 15/899,853

(22) Filed: Feb. 20, 2018

(30) Foreign Application Priority Data
Feb. 17, 2017 (IN) 201741005717PS
Sep. 26, 2017 (IN) 201741005717CS

(51) Int. Cl. H04M 1/725; G06F 3/0488

(52) U.S. Cl. CPC H04M 1/72547; G06F 3/0488

(57) ABSTRACT

A method and an electronic device are provided for managing information of an application. The method includes displaying a first user interface of the application on a screen of the electronic device, where the first user interface displays a first level of information of at least one data item of the application; detecting a slide input performed on the first user interface; determining a second level of information of the at least one data item based on a context of the at least one data item displayed in the first user interface; and displaying a second user interface including the second level of information of the at least one data item on the screen of the electronic device.

### CROSS-REFERENCE TO RELATED APPLICATION

This application is based on and claims priority under 35 U.S.C. § 119(a) to Indian Patent Application No. 201741005717 (PS), which was filed in the Indian Patent Office on Feb. 17, 2017, and Indian Patent Application No. 201741005717 (CS), which was filed in the Indian Patent Office on Sep. 26, 2017, the disclosure of each of which is incorporated by reference herein in its entirety.

### BACKGROUND

### 1. Field

The present disclosure relates generally to content management, and more particularly, to a method and an electronic device for managing information of an application.

### 2. Description of the Related Art

In general, a user of an electronic device performs series of steps in order to complete a task within an application. Although user-interface designs have evolved, performing the series of steps within the application is still required for completing most tasks.

### SUMMARY

Accordingly, the present disclosure is designed to address at least the problems and/or disadvantages described above and to provide at least the advantages described below.

In accordance with an aspect of the present disclosure, method is provided for managing information of an application in an electronic device. The method includes displaying a first user interface of the application on a screen of the electronic device, where the first user interface displays a first level of information of at least one data item of the application, detecting a first gesture input performed on the first user interface, determining a second level of information of the at least one data item based on a context of the at least one data item displayed in the first user interface, and displaying a second user interface including the second level of information of the at least one data item on the screen of the electronic device.

In accordance with another aspect of the present disclosure, a method is provided for managing information of an application in an electronic device. The method includes displaying a first user interface of the application on a screen of the electronic device, where the first user interface displays at least one first data item of the application, detecting a gesture input performed on the first user interface, determining at least one second data item based on a context of the at least one data item displayed in the first user interface, and displaying a second user interface including the at least one second data item of the application on the screen of the electronic device.

In accordance with another aspect of the present disclosure, an electronic device is provided for managing information of an application. The electronic device includes a memory storing the application; and a processor coupled to the memory. The processor is configured to control displaying of a first user interface of the application on a screen of the electronic device, where the first user interface displays a first level of information of at least one data item of the application, detect a first gesture input performed on the first user interface, determine a second level of information of the at least one data item based on a context of the at least one data item displayed in the first user interface, and control displaying of a second user interface including the second level of information of the at least one data item on the screen of the electronic device.

In accordance with another aspect of the present disclosure, an electronic device is provided for managing information of an application. The electronic device includes a processor and a memory storing the application. The processor is configured to control displaying of a first user interface of the application on a screen of the electronic device, where the first user interface displays at least one first data item of the application; and detect a first gesture input performed on the first user interface, determine at least one second data item based on a context of at least one data item displayed in the first user interface, and control displaying of a second user interface including the at least one second data item of the application on the screen of the electronic device.

### BRIEF DESCRIPTION OF DRAWINGS

The above and other aspects, features, and advantage of certain embodiments of the present disclosure will be more apparent from the following description taken in conjunction with the accompanying drawings, in which:

FIGS. 1A and 1B illustrate an example scenario in which a notification panel is invoked by a user on a user interface of a messaging application;

FIGS. 2A and 2B illustrate an example scenario in which a second user interface is invoked by a user on the user interface of the messaging application, according to an embodiment;

FIG. 3A is a block diagram illustrating various hardware components of an electronic device, according to an embodiment;

FIG. 3B is a block diagram illustrating various hardware components of a processor, according to an embodiment;

FIG. 4 is a flowchart illustrating a method of providing additional information of at least one data item on the second user interface of the electronic device, according to an embodiment;

FIG. 5 is a flowchart illustrating a method of switching between a first user interface and the second user interface based on a context of the at least one data item, according to an embodiment;

FIG. 6 is a flowchart illustrating a method of determining the additional information of an application in response to detecting a gesture on respective items in a user interface of the application, according to an embodiment;

FIGS. 7A, 7B, 7C, 7D and 7E illustrate another example scenario in which the second user interface, displaying additional information, is invoked by a user on the user interface of the messaging application, according to an embodiment;

FIGS. 8A, 8B and 8C illustrate an example scenario in which a second user interface, displaying the additional information, is invoked on a user interface of a call log application, according to an embodiment;

FIGS. 9A, 9B and 9C illustrate an example scenario in which a second user interface, displaying additional information, is invoked on a user interface of a lock screen, according to an embodiment;

FIGS. 10A, 10B and 10C illustrate an example scenario in which a second user interface, displaying additional information, is invoked on a user interface of a home screen, according to an embodiment;

FIGS. 11A, 11B, and 11C is an example scenario in which a second user interface, displaying additional information, is invoked on a user interface of a gallery application, according to an embodiment;

FIGS. 12A, 12B, 12C and 12D illustrate an example scenario in which a second user interface, displaying additional information of an object, according to an embodiment;

FIG. 13 is a flowchart illustrating a method of determining a second data item based on the context of a first data item of the first user interface, according to an embodiment;

FIGS. 14A, 14B, and 14C illustrate an example scenario in which a second user interface, displaying additional information, is invoked on a user interface of a home screen, according to an embodiment;

FIGS. 15A, 15B, and 15C illustrate an example scenario in which a second user interface, displaying additional information, within a user interface of a live camera is invoked, according to an embodiment;

FIGS. 16A, 16B and 16C illustrate an example scenario in which a second user interface, displaying images with a same context, is invoked on a user interface of the gallery application, according to an embodiment;

FIGS. 17A and 17B illustrate an example scenario in which a second user interface, displaying additional information, is invoked on a user interface of a contact application, according to an embodiment;

FIG. 18 is a flowchart illustrating a method of extracting and using contextual coupons in relevant applications, according to an embodiment;

FIGS. 19A, 19B, 19C and 19D illustrate an example scenario in which a second user interface, displaying contextual coupons, is invoked on a user interface of an advertisement application, according to an embodiment;

FIG. 20 is a flowchart illustrating a method of changing the existing view of the electronic device to display additional information related to a data item, according to an embodiment;

FIGS. 21A, 21B, 21C, and 21D illustrate an example scenario in which a second user interface, displaying additional information of objects, is invoked within a user interface of a live camera, according to an embodiment;

FIGS. 22A, 22B, 22C, and 22D illustrate another example scenario in which a second user interface, displaying additional information of an object, is invoked within a user interface of the live camera, according to an embodiment;

FIGS. 23A, 23B, and 23C illustrate an example scenario in which a second user interface, providing a call option, is invoked on a user interface of the gallery application, according to an embodiment;

FIGS. 24A, 24B, 24C, and 24D illustrate an example scenario in which a second user interface, displaying additional information related to a plurality of objects, is invoked within a user interface of the live camera, according to an embodiment;

FIGS. 25A, 25B, 25C, 25D, and 25E illustrate an example scenario in which a second user interface, displaying a new wallpaper and/or theme is invoked on a user interface of a home screen, according to an embodiment;

FIGS. 26A, 26B, 26C, 26D, and 26E illustrate an example scenario in which a second user interface, displaying additional information, is invoked on a user interface of a map application, according to an embodiment;

FIGS. 27A, 27B, 27C, 27D, and 27E illustrate an example scenario in which a second user interface, displaying a different gallery folder, is invoked on a user interface of a gallery application, according to an embodiment; and

FIGS. 28A, 28B, and 28C illustrate an example scenario in which a second user interface, displaying additional information, is invoked on a user interface of a calendar application, according to an embodiment.

### DETAILED DESCRIPTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those of ordinary skill in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those of ordinary skill in the art to practice the embodiments herein. Accordingly, the examples should not be construed as limiting the scope of the embodiments described herein.

As is traditional in the field, embodiments may be described and illustrated in terms of blocks which carry out a described function or functions. These blocks, which may be referred to herein as units, engines, managers, modules, etc., are physically implemented by analog and/or digital circuits such as logic gates, integrated circuits, microprocessors, microcontrollers, memory circuits, passive electronic components, active electronic components, optical components, hardwired circuits, etc., and may optionally be driven by firmware and/or software. The circuits may, for example, be embodied in one or more semiconductor chips, or on substrate supports such as printed circuit boards, etc. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiments herein provide a method of managing information of an application in an electronic device. The method includes displaying a first user interface of the application on a screen of the electronic device, where the first user interface displays a first level of information of at least one data item of the application; and detecting a slide input performed on the first user interface. Further, the method includes determining a second level of information of the at least one data item based on a context of the at least one data item displayed in the first user interface and displaying a second user interface comprising the second level of information of the at least one data item on the screen of the electronic device.

Accordingly the embodiments herein provide a method of managing information of an application in an electronic device. The method includes displaying a first user interface of the application on a screen of the electronic device, where the first user interface displays at least one first data item of the application; and detecting a slide input performed on the first user interface. Further, the method includes determining at least one second data item based on a context of the at least one data item displayed in the first user interface and displaying a second user interface comprising the at least one second data item of the application on the screen of the electronic device.

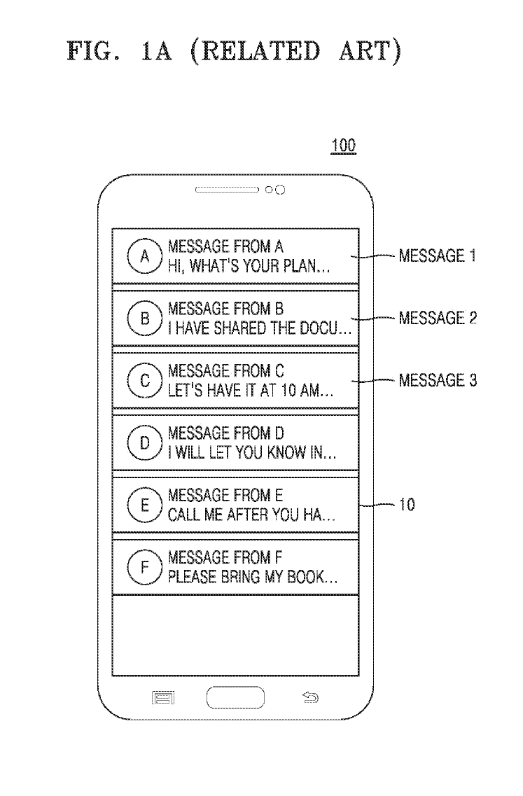

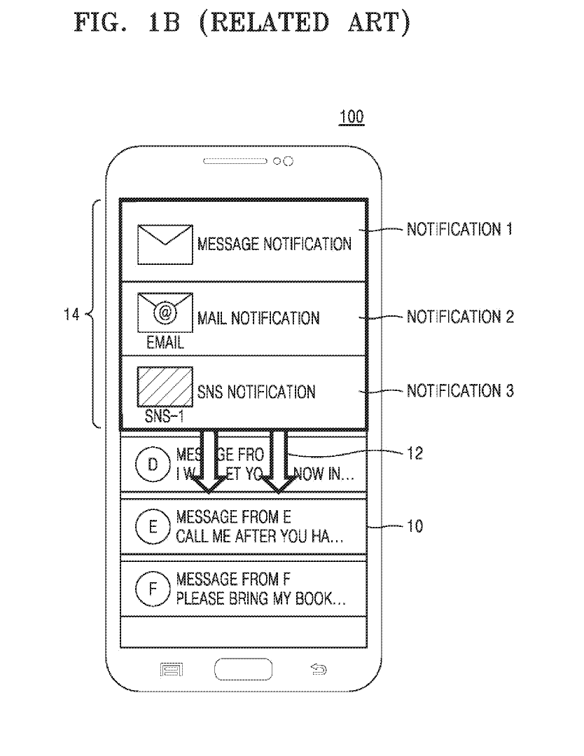

FIGS. 1A and 1B illustrate an example scenario in which a notification panel is invoked by a user on a user interface of a messaging application.

Referring to FIG. 1A, when a user accesses a messaging application 10, a user interface of the messaging application 10 displays a list of messages, i.e., message 1, message 2, message 3, etc., received from a plurality of senders. If the user wants to read/view the entire content of the message 1, then the user may have to access the message 1.

Further, if the user wishes to read the entire content of the message 2, then the user may have to navigate back to the user interface of the messaging application 10 and select the message 2 to access it. Likewise, similar steps are performed by the user in order to explore the contents in the message 3.

Referring to FIG. 1B, the user may perform a gesture 12 to revoke the notification panel 14 including the plurality of notifications (as illustrated in FIG. 1B).

Conventionally, a portion of the content in the message 1 and the message 2 can be displayed to the user. Otherwise, in order to access and explore the entire content or more than the portion of the content in each of the message 1 and the message 2, the user still has to perform the aforementioned steps, thus degrading user experience while using the messaging application, or while using any other application of the electronic device in a similar manner.

Thus, it is desired to address the above mentioned disadvantages or other shortcomings or at least provide a useful alternative.

Unlike conventional methods and systems (e.g., as detailed in FIGS. 1A and 1B), in accordance with an embodiment of the present disclosure, a proposed method can be used to provide an intelligent layer (i.e., a second user interface) configured to display additional information (first level of information, second level of information, etc.) of the data items present in the second user interface. Thus, in addition to the notification panel 14, an electronic device can be configured to detect a pre-defined gesture to invoke the second user interface.

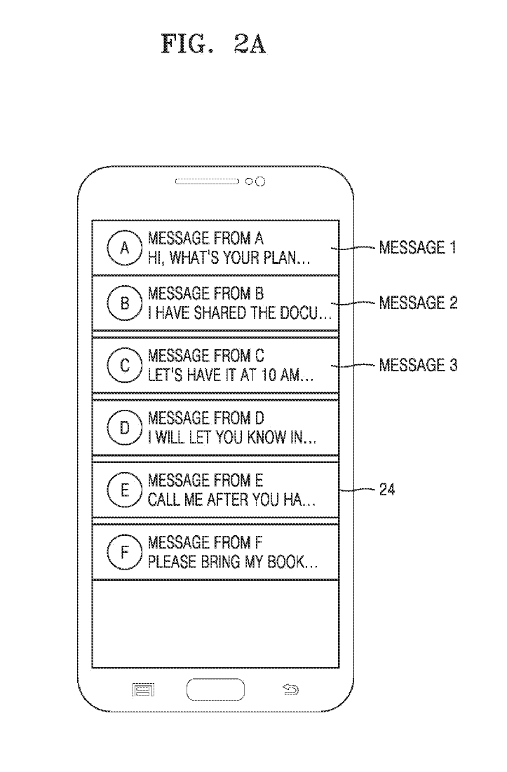

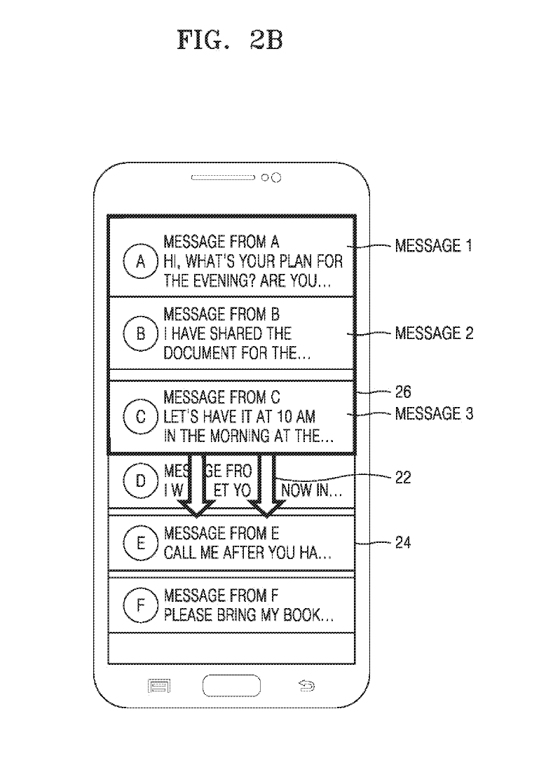

FIGS. 2A and 2B illustrate an example scenario in which a second user interface is invoked by a user on a user interface of a messaging application, according to an embodiment.

Referring to FIG. 2A, unlike the conventional methods and systems, the proposed method can be used to invoke a second user interface 26 within a first user interface 24 of the messaging application. The second user interface 26 comprises the additional information of the at least one data item (i.e., messages 1, messages 2, messages 3, etc.) present in the first user interface 24. The additional information can be, for example, an additional portion of the content (in addition to the portion of the content previously displayed) from each of the at least one data item present in the second user interface 26 (e.g., focus area). Thus, the user experience may be improved, as the series of steps (as detailed in the FIGS. 1A-1B) involved in accessing the content present within each of the messages are eradicated. Thus, the user may be able to view the entire content present in each of the data item (messages 1, 2, and 3) without accessing them.

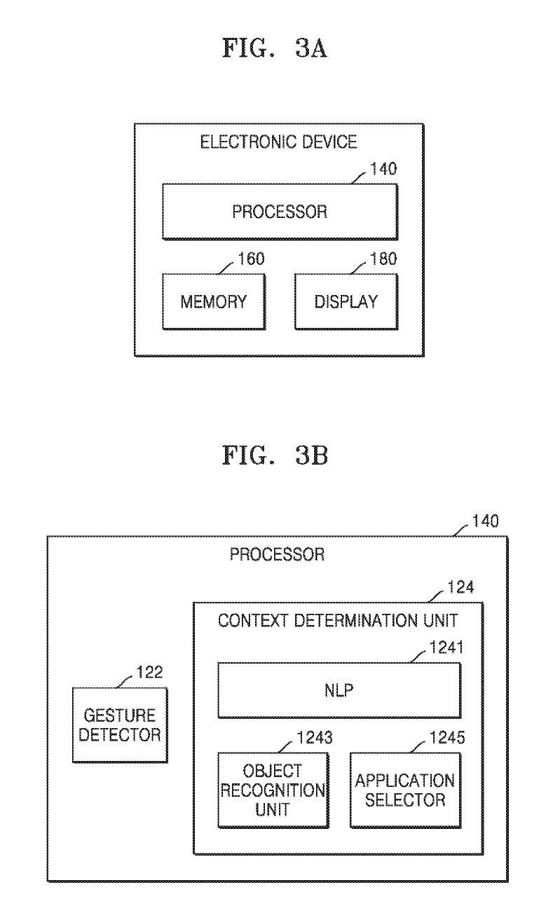

FIG. 3A is a block diagram illustrating various hardware components of an electronic device, according to an embodiment.

Referring to FIG. 3A, the electronic device may be a mobile phone, a smart phone, a personal digital assistants (PDA), a tablet, a wearable device, a display device, an Internet of things (IoT) device, an electronic circuit, a chipset, an electrical circuit (i.e., system on chip (SoC)), etc.

The electronic device includes a processor 140, a memory 160 and a display 180.

The processor 140 can be configured to display the first user interface of the application on the screen of the electronic device. The first user interface displays the first level of information of at least one data item of the application.

For example, in a scenario in which the user of the electronic device accesses the messaging application displaying a list of messages received from various contacts, one of the messages (e.g., message 1) reads “Hi friend. How are you? What are your plans for the evening? Let's catch up at 6!”

When the user in the above scenario, he or she will be able to view only the first level of information i.e., “Hi friend. How are you?” of the message without opening the message. The proposed method can be used to provide the second user interface comprising the second level of information, without opening the message 1, as detailed below.

According to the proposed method, the processor 140 detects the first gesture provided by the user on the first user interface. In response to the detected first gesture, the processor 140 determines the availability of the second level of information of the message 1. Upon determining, the availability of the second level of information, the processor 140 can control to display the second user interface comprising the second level of information of the message 1 on the screen of the electronic device.

As illustrated in the FIG. 2B, the second level of information of message 1 is “Hi friend. How are you? What are your plans for the evening?” i.e., an extra line of the content of the message 1 (What are your plans for the evening?) is displayed in accordance with the content provided in the first user interface.

Further, on detecting subsequent gesture input which is the second gesture input, the processor 140 may determine and control to display the third level of information of the message 1 on the screen of the electronic device. For example, the third level of information “Let's catch up at 6!” is displayed. Thus, processor 140 can be configured to determine and control to display the entire content of message 1 “Hi friend. How are you? What are your plans for the evening? Let's catch up at 6!” (based on the subsequent gestures), without requiring the user to access (navigate within) the message 1 displayed on the user interface of the messaging application. The first gesture input and the second gesture input may be different from each other in their directions and/or the type of each of the gesture—i.e. a slide gesture, a rail gesture, a swipe gesture, a flick gesture, a scroll gesture, a flex gesture, a tapping gesture, etc.

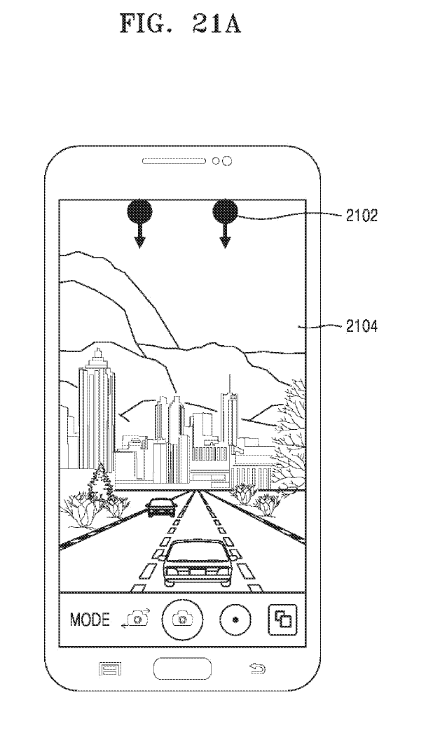

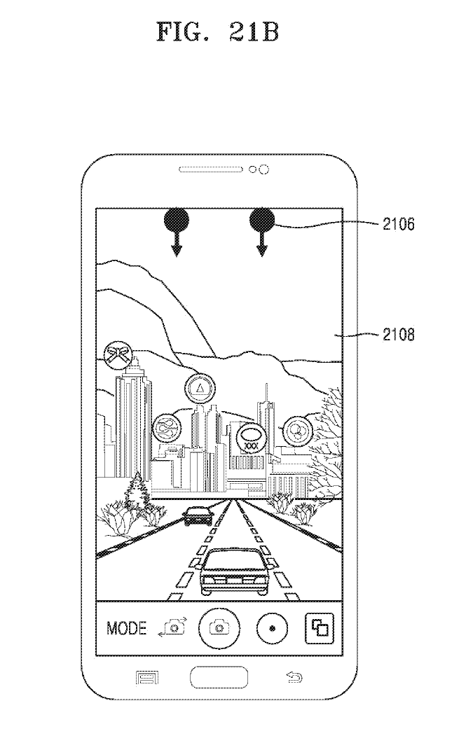

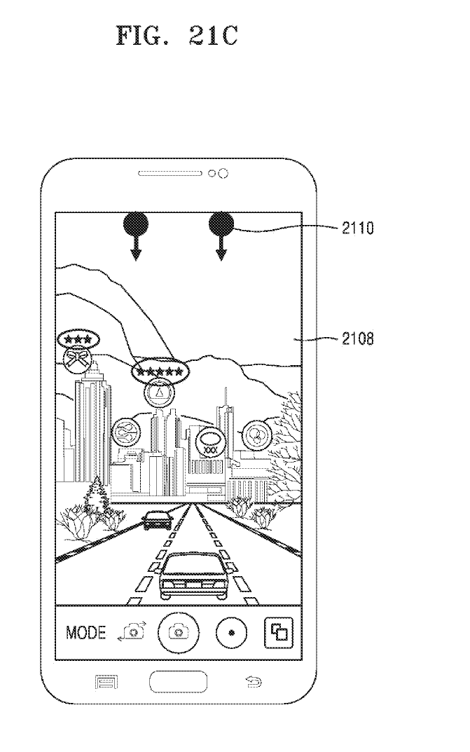

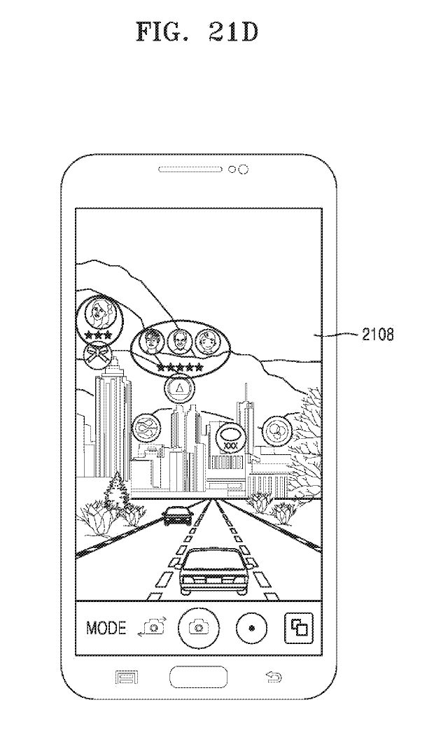

In another example, if the user accesses a live camera mode of a camera application, the field of view of the live camera displays a first level of information i.e., view of a street in which objects such as banks, stores, grocery shops, restaurants, etc., are displayed on a first user interface. When the processor 140 detects the gesture on the first user interface, then the processor 140 invokes the second user interface detailing a second level of information of the objects in the field of view of the live camera. The second level of information can include, for example, additional information of the objects in the field of view of the live camera mode such as offers currently running in the stores, menu details of the restaurants, review/ratings of the restaurant, details about the contacts who have checked in to the restaurants, etc., e.g., as illustrated in FIGS. 21A-21D.

The proposed method can also be used to automatically switch between a live camera mode to an augmented reality (AR) mode based on the context of the objects present in the field of view of the live camera mode of the camera application.

The processor 140 can be configured to interact with the hardware components in the electronic device to perform the functionalities of the corresponding hardware components.

The memory 160 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 160 may, in some examples, be considered a non-transitory storage medium. The term “non-transitory” may indicate that the storage medium is not embodied in a carrier wave or a propagated signal. However, the term “non-transitory” should not be interpreted that the memory 160 is non-movable. In some examples, the memory 160 can be configured to store larger amounts of information than the memory. In certain examples, a non-transitory storage medium may store data that can, over time, change (e.g., in Random Access Memory (RAM) or cache).

The display 180, based on receipt of a control command from the processor 140, manages the display of information in the first user interface and the second user interface displayed on the screen of the electronic device. The screen can include, for example, a touch screen, the touch screen may use a liquid crystal display (LCD) technology, a light emitting polymer display (LPD) technology, an organic light emitting diode (OLED), or an organic electro luminescence (OEL) device, although other display technologies may be used in other embodiments.

FIG. 3B is a block diagram illustrating various hardware components of a processor, according to an embodiment.

Referring to FIG. 3B, the processor 140 includes a gesture detector 122, and a context determination unit 124.

The first user interface displays the first level of information of the data item of the application. The application can include for example, the messaging application, an instant messaging/chat application, a camera application, a browser, an address book, a contact list, an email application, location determination capability (such as that provided by the global positioning system (GPS)), a social networking service (SNS) application, etc. The first level of information can include, for example, the portion of a content, associated with the data item i.e., a single line of the text message in case of the messaging application, the contact numbers in case of the contact list, a captured picture in case of the camera application, etc.

The gesture detector 122 is configured to receive the gesture performed by the user on the screen of the electronic device. The gesture can be, for example, a slide gesture, a rail gesture, a swipe gesture, a flick gesture, a scroll gesture, a flex gesture, etc. The gesture can be a user defined, Original Equipment Manufacturer (OEM) defined or defined by an operating system running in the electronic device.

The context determination unit 124 can be configured to determine the context of the at least one data item displayed in the first user interface and the second user interface. In an embodiment, the context determination unit 124 comprises a natural language processor (NLP) 1241, an object recognition unit 1243 and an application selector 1245.

The NLP 1241 can be configured to parse the first level of the information and determines whether any additional information in the context of the first level of information is available. Upon determining that additional information in the context of the first level of information is available, then the NLP 1241 fetches the additional information from the context of the first level of information. The additional information can be for example, additional content of the text message in case of the messaging application, the contact number along with SNS data, or any other data associated with the contact number in case of contact list, the captured picture with the SNS data in case of the camera application, etc., which are based on the context of the data item displayed in the first user interface. Further, the additional information is displayed on the second user interface of the electronic device.

For example, when the first user interface of a call application displays the details of the call log featuring the contact details (i.e., first level of information), the user can provide a pre-defined gesture on a pre-defined portion of the call application to invoke the second user interface. Thus, the NLP 1241 can be configured to identify the contacts present within the second user interface and determines whether any contextual information (i.e., second level of information) associated with the contacts are available. The contextual information associated with the contacts can be for example, SNS data associated with the contact, tags associated with the contact, etc.

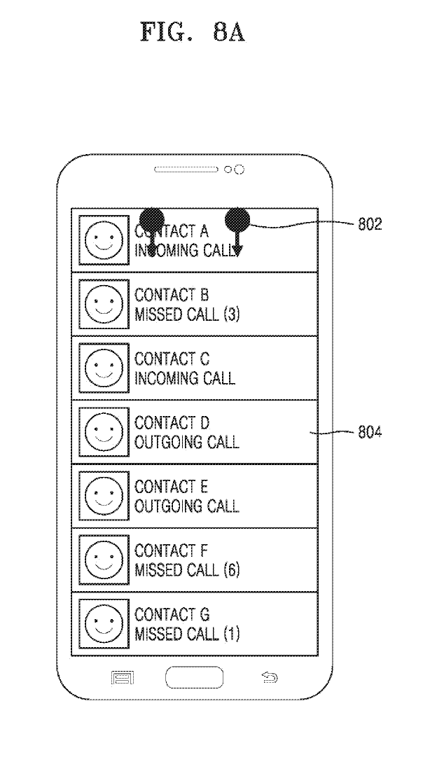

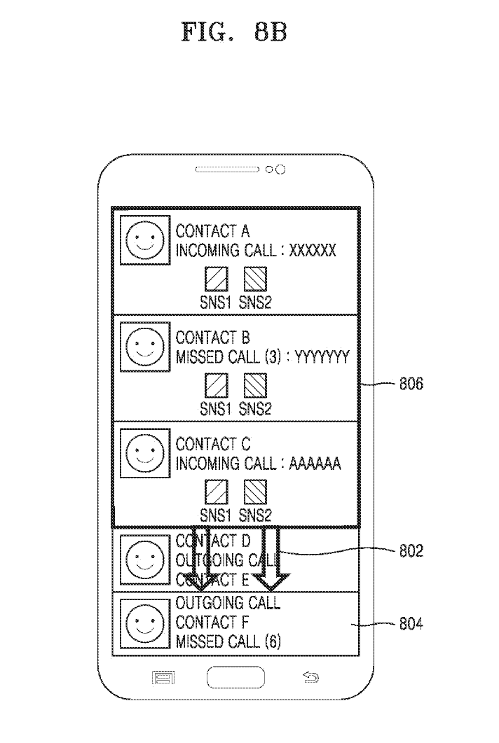

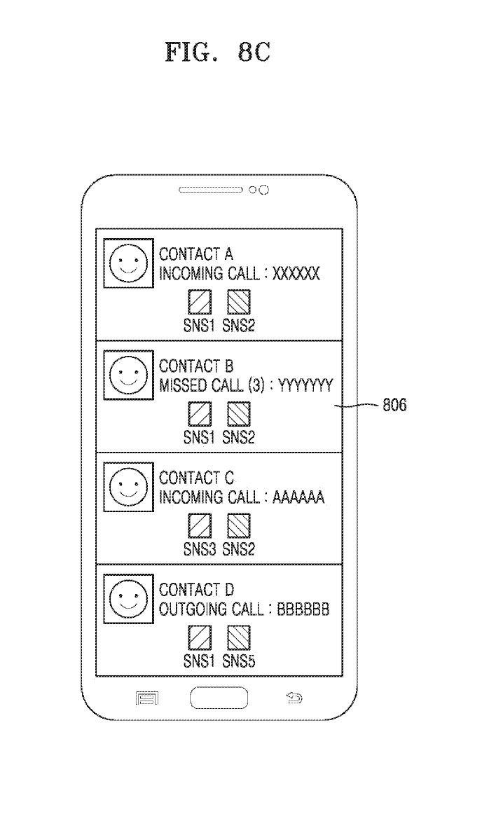

Upon determining that contextual information associated with at least one of contact is available, the NLP 1241 fetches the contextual information associated with the at least one of contact and displays in the second user interface of the electronic device, e.g., as illustrated in FIGS. 8A-8C.

The object recognition unit 1243 can be configured to determine the objects present in the first data item. The objects can be, for example, the objects in the field of view of the live camera mode of the camera application, objects in the gallery application, etc. Further, the object recognition unit 1243 determines information related to the objects present in the first data item. The information related to the objects present in the first data item can be for example, text extracted from the picture (object), accessories identified in the picture, etc.

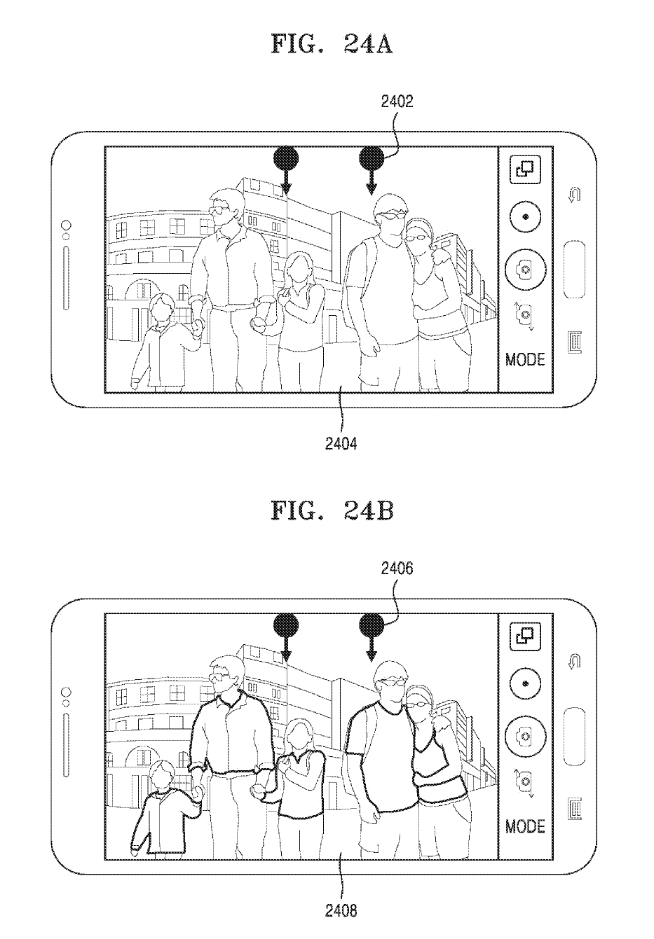

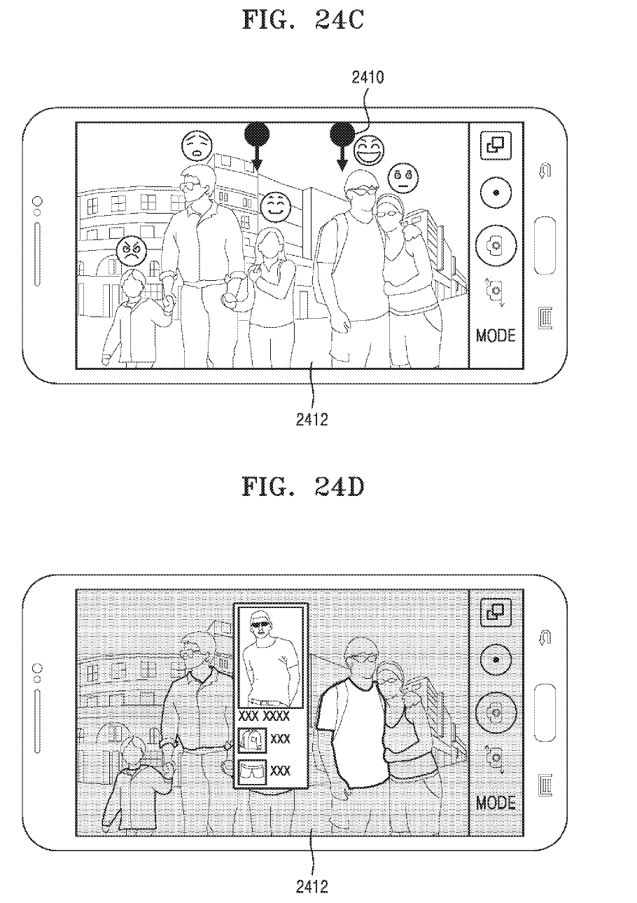

The application selector 1245 can be configured to determine a relevant application suitable to perform a relevant task, e.g., as illustrated in FIGS. 24A-24D, associated with an information associated with object displayed on the display screen of the electronic device. The relevant application is determined based on a context of the object (i.e., at least one data item) displayed in the first user interface.

For example, consider the first user interface of an application, in the electronic device, displaying an object (i.e., first data item) including data items such as contact details, address, e-mail, etc., based on the gesture detected on the first user interface, the object recognition unit 1243 can automatically determine the context (contact details, address, e-mail, etc.). Further, the application selector 1245 can be configured to automatically provide a relevant application (e.g., call application, the second data item) to perform at least one action based on the determined context. The action can include, but not limited to, launching a call log application, displaying the contact number on a dialer window of the log application. The NLP 1241, the object recognition unit 1243, and the application selector 1245 may be implemented as at least one hardware processor.

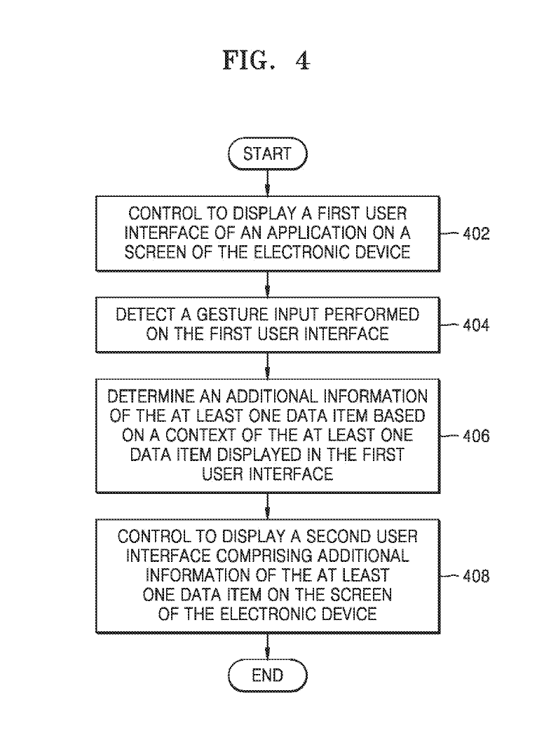

FIG. 4 is a flowchart illustrating a method of providing additional information of at least one data item on a second user interface of an electronic device, according to an embodiment.

Referring to FIG. 4, in operation 402, the electronic device displays the first user interface of the application on the display screen. For example, in the electronic device as illustrated in the FIG. 3A, the display 180 can be configured to display the first user interface of the application on the display screen.

In operation 404, the electronic device detects the gesture input such as a slide input performed on the first user interface. For example, in the electronic device as illustrated in the FIG. 3B, the gesture detector 122 can be configured to detect the slide input performed on the first user interface.

In operation 406, the electronic device determines the additional information of the at least one data item based on the context of the at least one data item displayed in the first user interface. For example, in the electronic device as illustrated in the FIG. 3B, the NLP 1241 can be configured to determine the additional information of the at least one data item based on the context of the at least one data item displayed in the first user interface.

In operation 408, the electronic device displays the second user interface comprising the additional information of the at least one data item on the display screen. For example, in the electronic device as illustrated in the FIG. 3A, the display 180 can be configured to display the second user interface comprising the additional information of the at least one data item on the display screen.

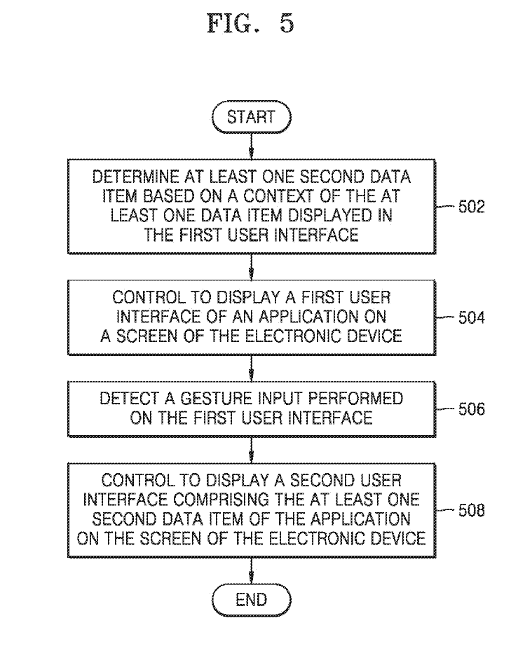

FIG. 5 is a flowchart illustrating a method of switching between a first user interface and a second user interface based on a context of at least one data item, according to an embodiment.

Referring to FIG. 5, in operation 502, the electronic device displays the first user interface of the application on the display screen. For example, in the electronic device as illustrated in the FIG. 3A, the processor 140 can be configured to display the first user interface of the application on the display screen.

In operation 504, the electronic device detects the gesture input such as a slide input performed on the first user interface. For example, in the electronic device as illustrated in the FIG. 3A, the processor 140 can be configured to detect the gesture input performed on the first user interface.

In operation 506, the electronic device determines at least one second data item based on a context of the at least one data item displayed in the first user interface. For example, in the electronic device as illustrated in the FIG. 3A, the application information manager 120 can be configured to determines at least one second data item based on a context of the at least one data item displayed in the first user interface.

In operation 508, the electronic device displays the second user interface comprising the at least one second data item of the application on the display screen. For example, in the electronic device as illustrated in the FIG. 1, the processor 140 can be configured to displays the second user interface comprising the at least one second data item of the application on the display screen.

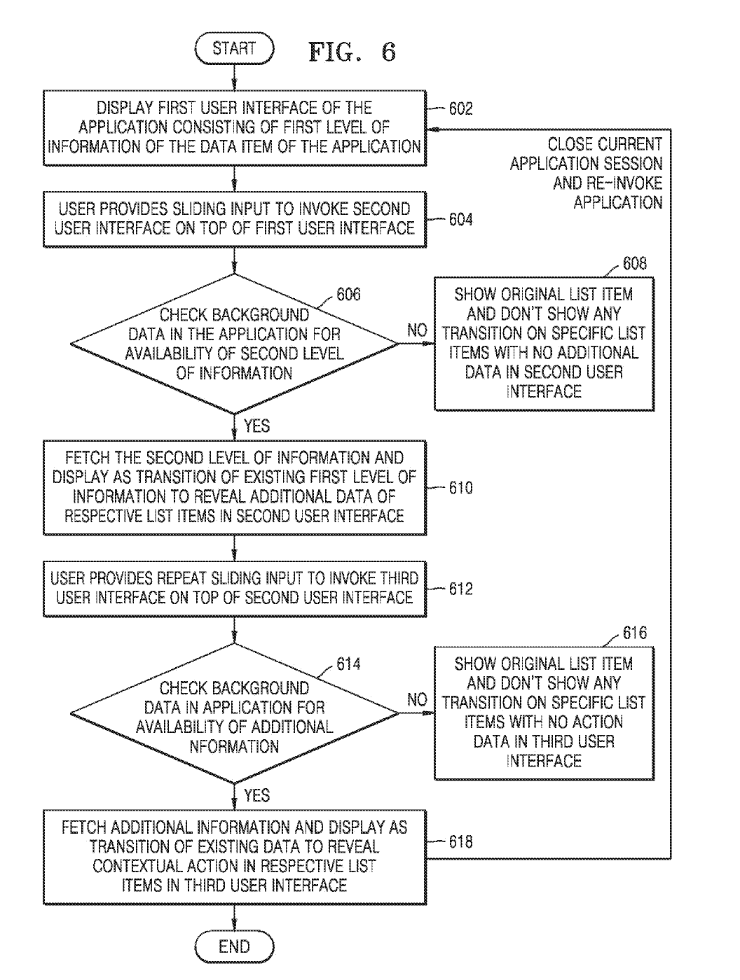

FIG. 6 is a flowchart illustrating a method of determining additional information of an application in response to detecting a gesture on a respective user interface of an application, according to an embodiment.

Referring to the FIG. 6, in operation 602, the electronic device displays the first user interface of the application consisting of first level of information of the data item of the application. For example, in the electronic device as illustrated in the FIG. 3A, the display 180 can be controlled to display the first user interface of the application consisting of first level of information of the data item of the application.

In operation 604, the electronic device allows the user to provide a gesture input such as a slide input to invoke the second user interface in addition to the first user interface. For example, in the electronic device as illustrated in the FIG. 3B, the gesture detector 122 can be configured to allow the user to provide the gesture input to invoke the second user interface on top of first user interface.

In operation 606, the electronic device checks the background data of the application for availability of the second level of information. For example, in the electronic device as illustrated in the FIG. 3B, the NLP 1241 can be configured to determine the background data of the application for availability of the second level of information.

In operation 608, upon determining that the background data of the application is unavailable, the display 180 displays original list item and does not show any transition on specific list items with additional data in second user interface. In another embodiment, the display 180 can be controlled to provide an indication (e.g., error message, graphical representation, etc.) indicating unavailability of the second level of information.

In operation 610, upon determining that the background data of the application is available, the electronic device fetches the second level of information. Further, the display 180 displays the second level of information as transition of existing first level of information to reveal additional data of the respective list items in the second user interface.

In operation 612, the electronic device, allows the user to provide a repeated gesture input to invoke third user interface (i.e., update to the second user interface) in addition to the second user interface. For example, in the electronic device as illustrated in the FIG. 3A, the gesture detector 122 can be configured to allow the user to provide a repeated gesture input to invoke third user interface on top of second user interface.

In operation 614, the electronic device checks the background data of the application for availability of additional information. For example, in the electronic device as illustrated in the FIG. 3A, the processor 140 can be configured to check the background data of the application for availability of additional information.

In operation 616, upon determining that additional information of the application is unavailable, the display 180 displays original list item and does not show any transition on specific list items with action data in third user interface.

In operation 618, upon determining that additional information of the application is available, the electronic device fetches the additional information. Further, the display 180 displays the additional information as transition of existing data to reveal contextual action in respective list items in third user interface.

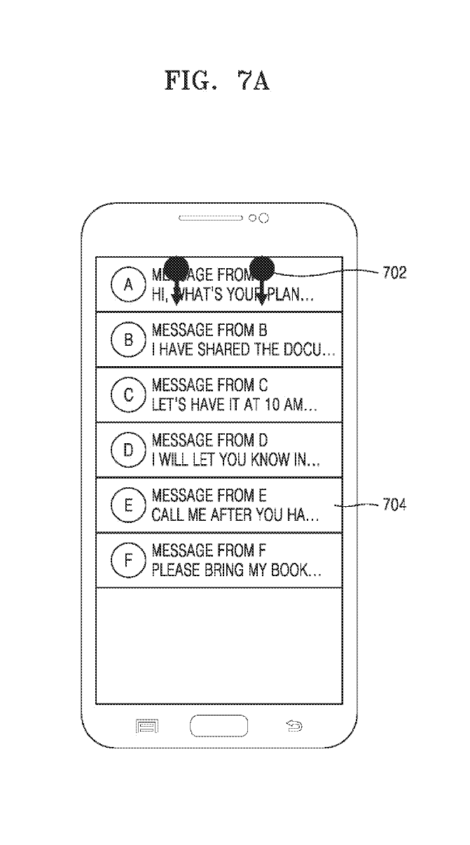

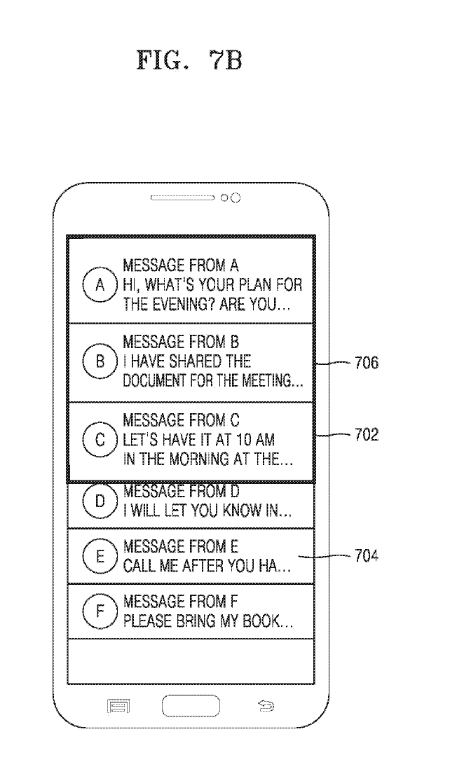

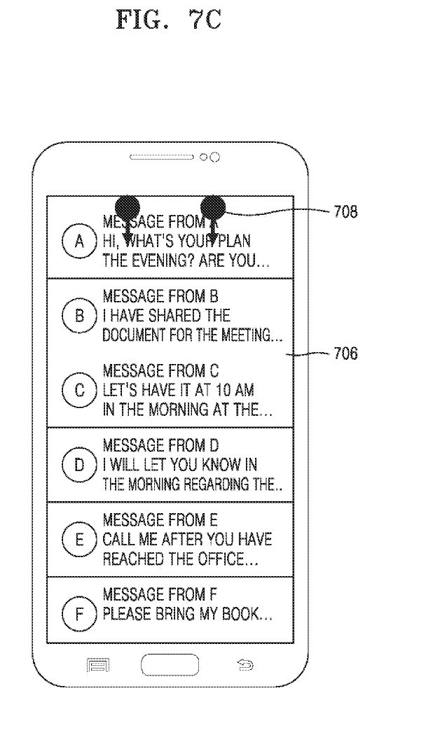

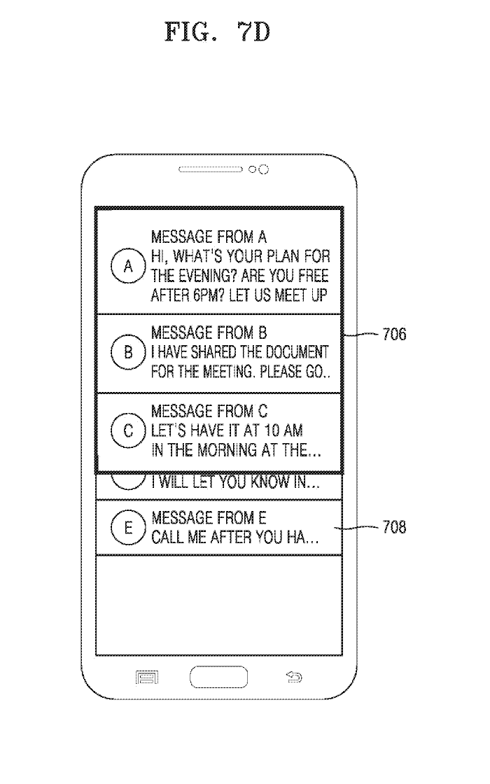

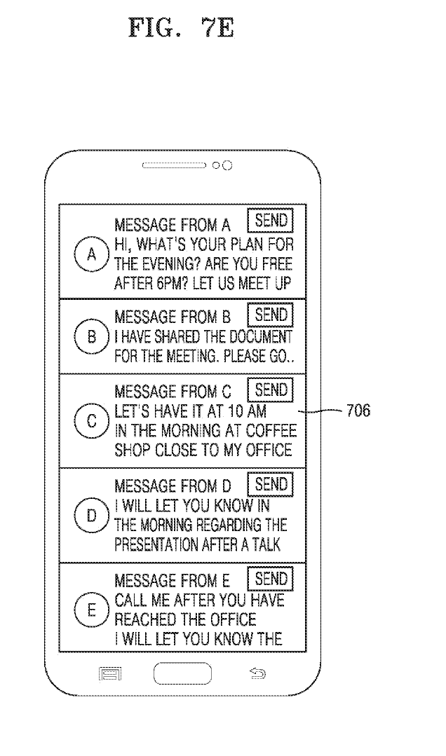

FIGS. 7A-7E illustrate another example scenario in which a second user interface, displaying additional information, is invoked by a user on a user interface of a messaging application, according to an embodiment.

In a scenario in which the user of the electronic device accesses the messaging application displaying the plurality of messages within the first user interface 704 of the messaging application, the proposed method can be used to provide the additional information (if any) associated with each message from the plurality of messages without requiring the user to access each message in order to view the additional information (e.g., extra lines of text for each message, attachments in the message, option to respond directly from the grid view, etc.) present therein.

The gesture detector 122 can be configured to detect the first gesture input 702 on the first user interface 704 (as illustrated in FIG. 7A). In response to detecting the first gesture input 702, the electronic device determines the second level of information (i.e., additional information) of the at least one message based on the context of at least one message displayed in the first user interface 704. Further, the processor 140 can be configured to display the second level of information associated with each of the messages in the second user interface 706 (as illustrated in FIG. 7B-7C).

Further, the gesture detector 122 can be configured to detect the second gesture input 708 on the second user interface 706 (as illustrated in FIG. 7C). In response to detecting the second gesture input 708, the electronic device can be configured to determine the third level of information (i.e., additional information) associated with at least one message based on the context of the at least one message displayed. The processor 140 can be configured to update the second user interface 706 to display the third level of information on the screen of the electronic device (as illustrated in FIG. 7D-7E).

In one or more embodiments, the user may be able to define an area to be covered by the second user interface 706 on the display screen of the electronic device.

FIGS. 8A-8C illustrate an example scenario in which a second UI, displaying additional information, is invoked on a user interface of a call log application, according to an embodiment.

In a scenario in which the user of the electronic device accesses the call log application displaying call details within a first user interface 804, the proposed method can be used to provide the additional information (if any) related to each of the contacts in the call log application without requiring the user to access each of the contacts to explore the additional information (e.g., contact number, call details, contact's presence in social networking sites, chat applications, messaging application, etc.) present therein.

The gesture detector 122 can be configured to detect the gesture input 802 on the first user interface 804 (as illustrated in the FIG. 8A). In response to detecting the gesture input 802, the electronic device determines the additional information (i.e., second level of information) related to the contacts based on the context of call details displayed in the first user interface 804. Further, the processor 140 can be configured to display the second level of information associated with the contact in the second user interface 806 (as illustrated in FIGS. 8B-8C).

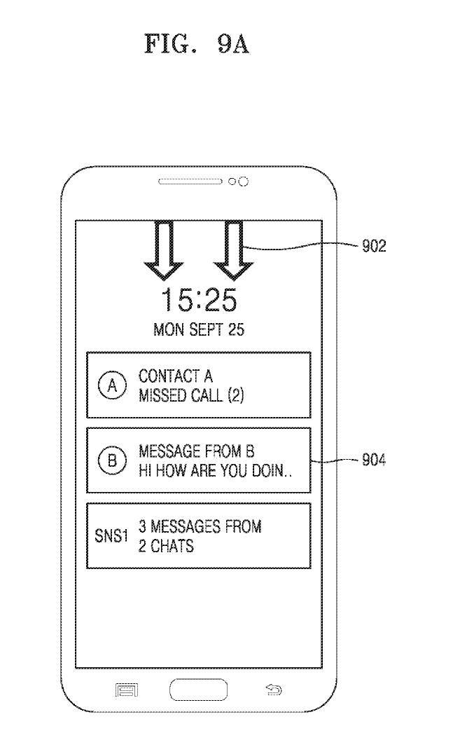

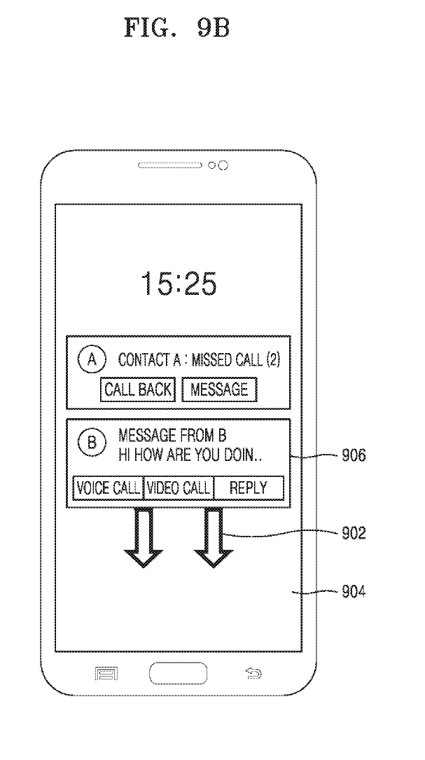

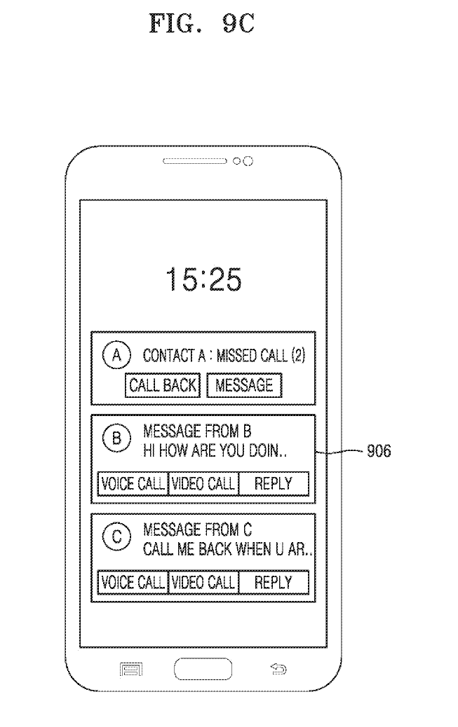

FIGS. 9A-9C illustrate an example scenario in which a second user interface, displaying additional information, is invoked on a user interface of a lock screen, according to an embodiment.

In a scenario in which a lock screen of the electronic device displays a plurality of notification messages in a first user interface 904, the proposed method can be used to provide the additional information (if any) related to the plurality of notification messages without requiring the user to unlock the lock screen and access the notifications messages to view the additional information (e.g., notification messages with extra details).

The gesture detector 122 can be configured to detect the gesture input 902 on the first user interface 904 (as illustrated in FIG. 9A). In response to detecting the gesture input 902, the electronic device determines the second level of information (i.e., additional information) related to each of the notification message based on the context associated with each of the notification message displayed in the first user interface 904. Further, the processor 140 can be configured to display the second level of information associated with each of the notification message displayed within the second user interface 906 (as illustrated in FIG. 9B-9C).

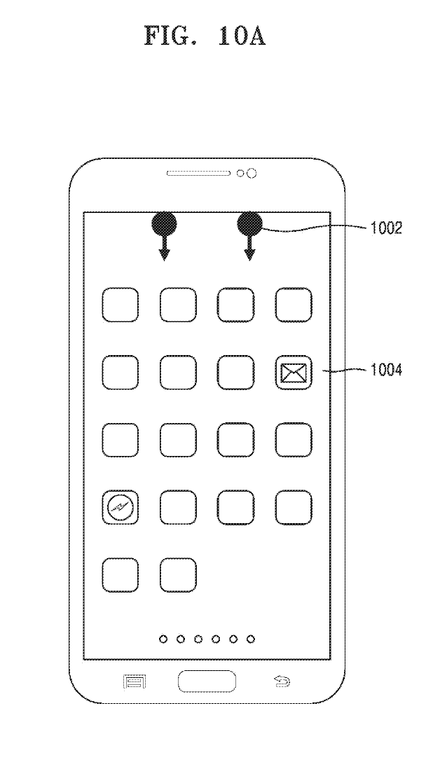

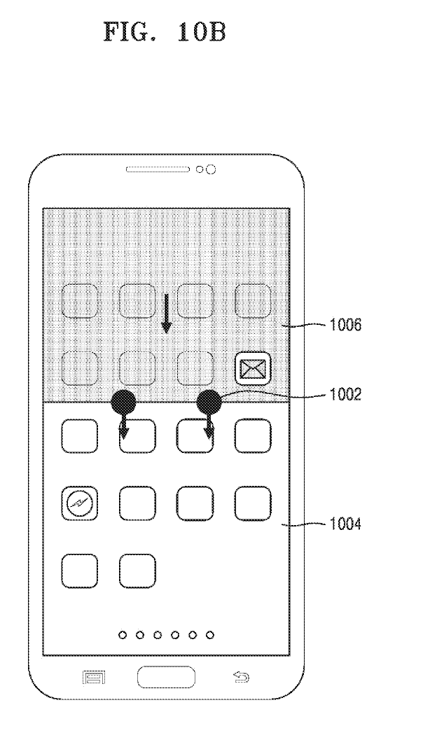

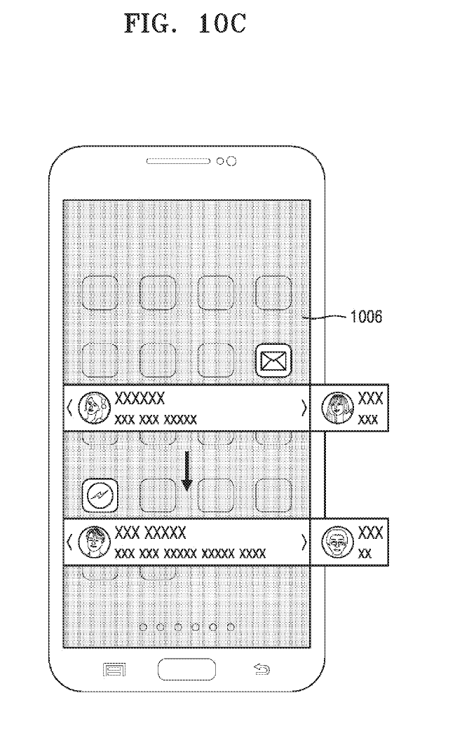

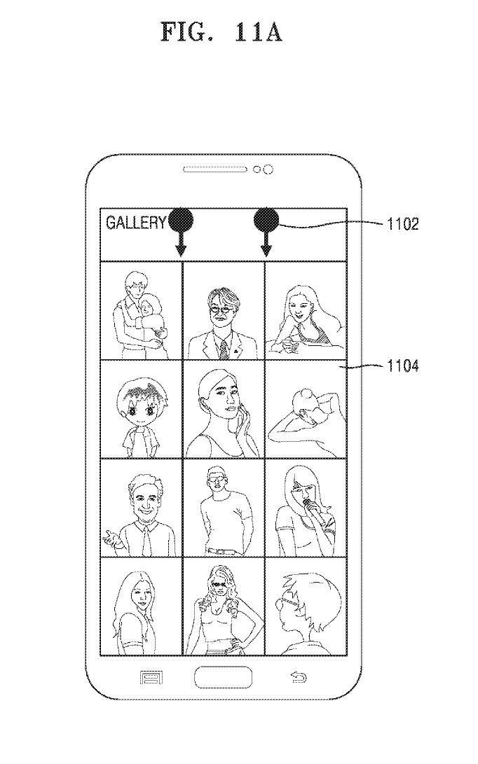

FIGS. 10A-10C illustrate an example scenario in which a second user interface, displaying additional information, is invoked on a first user interface of a home screen, according to an embodiment.

In a scenario in which icons of a plurality of applications are displayed within a first user interface 1004 of the home screen, The proposed method can be used to provide the additional information (e.g., latest notification of the applications, etc.) (if any) related to the plurality of applications without requiring the user to access the plurality of applications thereof.

The gesture detector 122 can be configured to detect a gesture input 1002 on the icon of at least one application displayed within the first user interface 1004 (as illustrated in FIG. 10A). In response to detecting the gesture input 1002, the electronic device determines a second level of information (i.e., additional information) of the plurality of applications based on the context of plurality of applications displayed in the first user interface 1004. Further, the processor 140 can be configured to display the second level of information associated with the plurality of applications in a second user interface 1006 (as illustrated in FIG. 10B-10C).

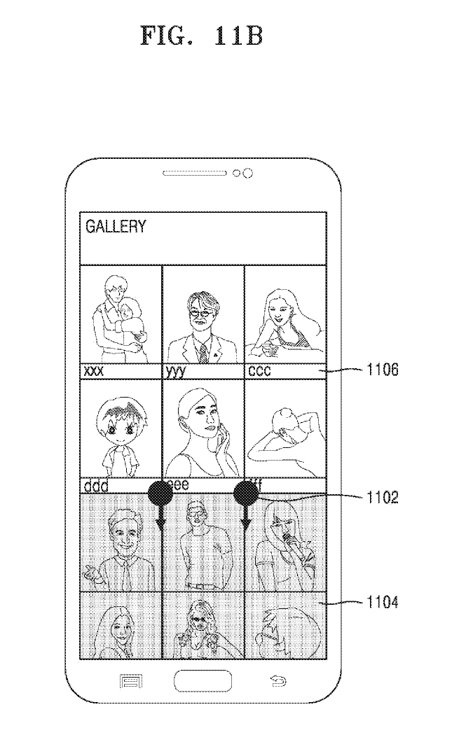

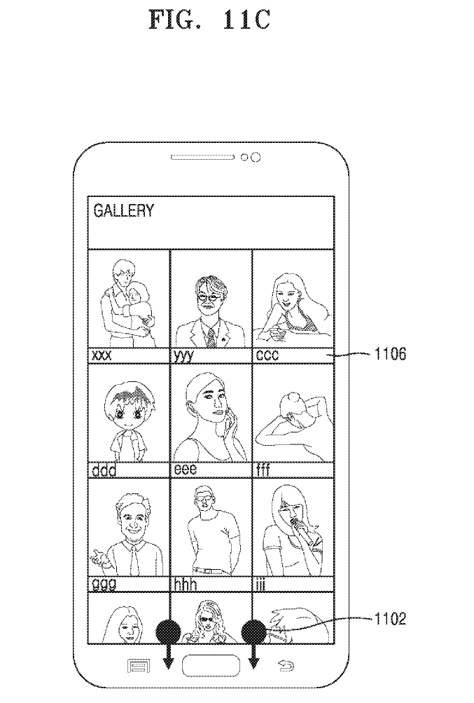

FIGS. 11A-11C illustrate an example scenario in which a second user interface, displaying additional information, is invoked on a user interface of a gallery application, according to an embodiment.

In a scenario in which the user of the electronic device accesses the gallery application displaying a plurality of images within a first user interface 1104, the proposed method can be used to provide the additional information (if any) of the plurality of images without requiring the user to access each image in order to retrieve the additional information (e.g., size of the image, image type, social networking presence, etc.) thereof.

The gesture detector 122 can be configured to detect the gesture input 1102 on the first user interface 1104 (as illustrated in FIG. 11A). In response to detecting the gesture input 1102, the electronic device determines the second level of information (i.e., additional information) of the plurality of images based on the context of the plurality of images displayed in the first user interface 1104. Further, the processor 140 can be configured to display the second level of information associated with plurality of images in the second user interface 1106 (as illustrated in FIG. 11B-11C).

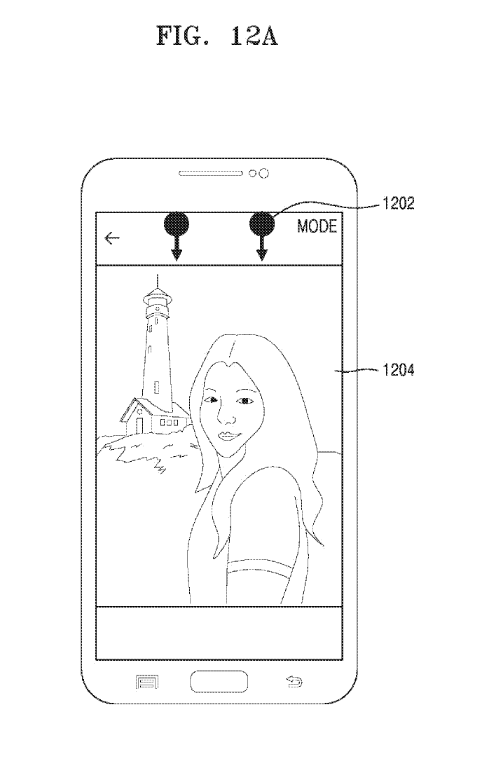

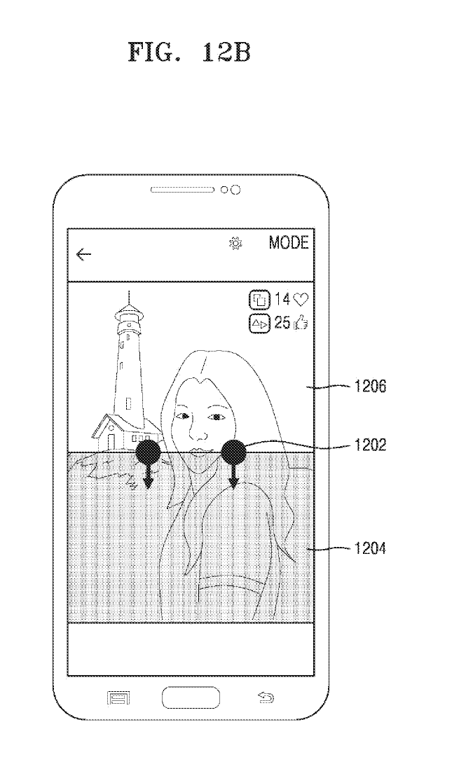

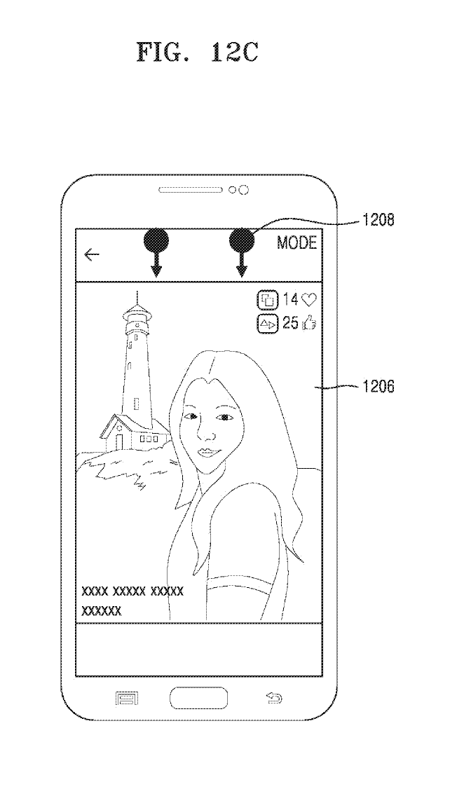

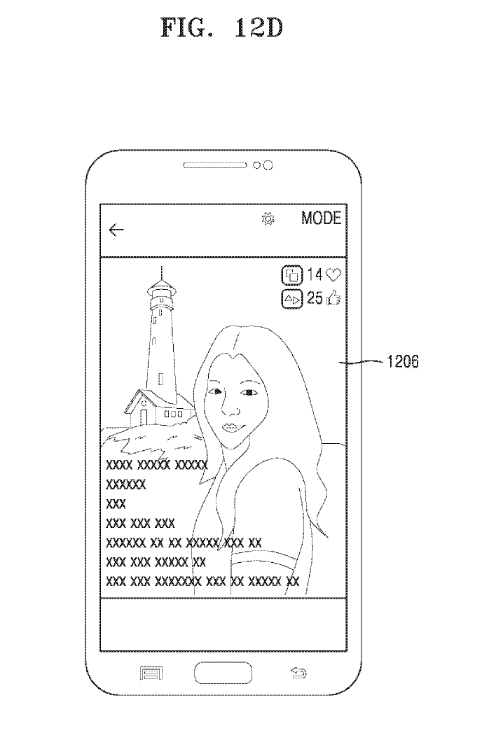

FIGS. 12A-12D illustrate an example scenario in which a second user interface, displaying additional information of an object, according to an embodiment.

In a scenario in which the user of the electronic device accesses the gallery application in which an object (e.g., image) is displayed in a first user interface 1204, the proposed method can be used to provide the additional information (if any) about the image without requiring the user to browse for the additional information (e.g., size of the image, image type, etc.) thereof.

The gesture detector 122 can be configured to detect a first gesture input 1202 on the first user interface 1204 (as illustrated in FIG. 12A). In response to detecting the first gesture input 1202, the electronic device determines the second level of information (i.e., additional information) related to the image based on the context of the image displayed in the first user interface 1204. Further, the processor 140 can be configured to display the second level of information associated with the image in the second user interface 1206 (as illustrated in FIGS. 12B-12C). The second level of information associated with the image can be the SNS data related to the image, the location where the image was taken, etc.

Furthermore, the gesture detector 122 can be configured to detect the second gesture input 1208 on the second user interface 1206 (as illustrated in FIG. 12C). In response to detecting the second gesture input 1208, the electronic device determines the third level of information (i.e., additional information) related to the image based on the context of the image displayed in the second user interface 1206. Further, the processor 140 can be configured to display the third level of information associated with the image in the updated second user interface 1210 (as illustrated in FIG. 12D).

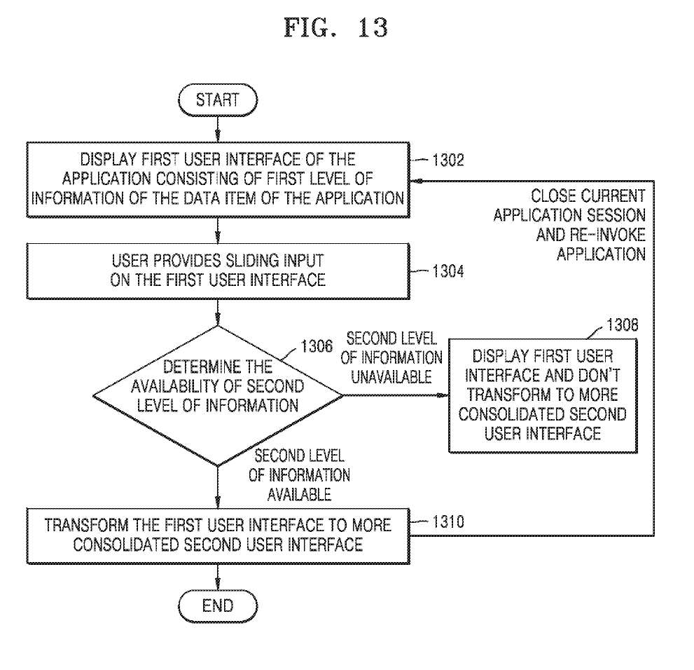

FIG. 13 is a flowchart illustrating a method of determining a second data item based on a context of a first data item of a first user interface, according to an embodiment.

Referring to FIG. 13, in operation 1302, the electronic device displays the first user interface of the application consisting of first level of information of the data item of the application. For example, in the electronic device as illustrated in the FIG. 3A, the display 180 can be controlled to display the first user interface of the application consisting of first level of information of the data item of the application.

In operation 1304, the electronic device allows the user to provide a gesture input such as a sliding input on the first user interface. For example, in the electronic device as illustrated in the FIG. 3B, the gesture detector 122 can be configured to allow the user to provide a sliding input on the first user interface.

In operation 1306, the electronic device determines the availability of the second level of information. For example, in the electronic device as illustrated in the FIG. 3A, the processor 140 can be configured to determine the availability of the second level of information.

In operation 1308, on the determining that the second level of information is not available, the display 180 displays the first user interface and does not transform to a more consolidated second user interface.

In operation 1310, on the determining that the second level of information is available, the display 180 transforms the first user interface to more consolidated second user interface.

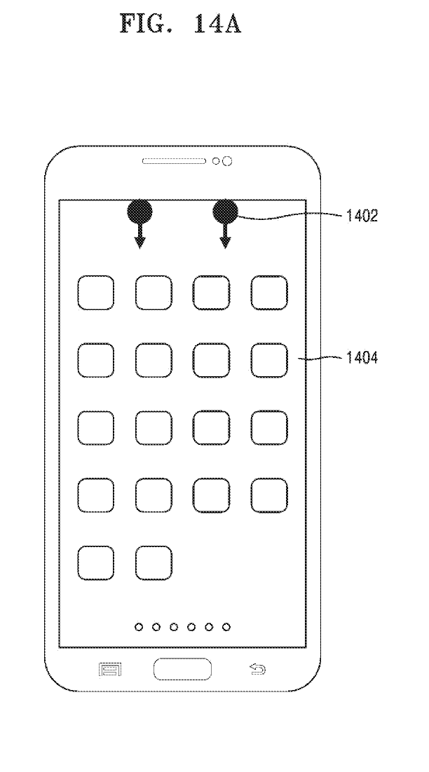

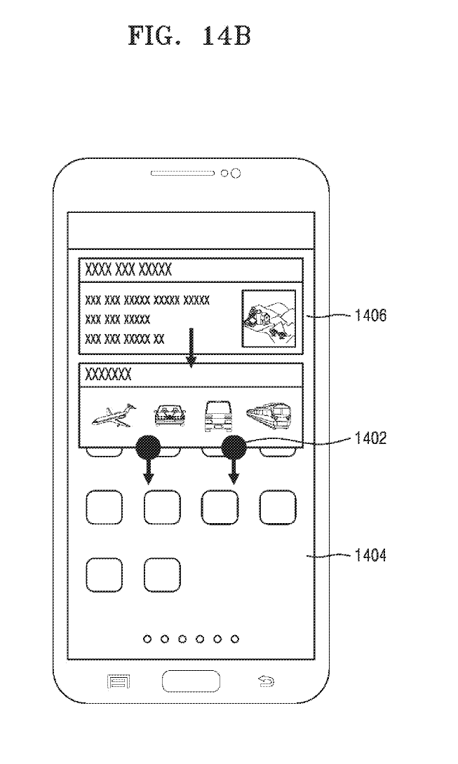

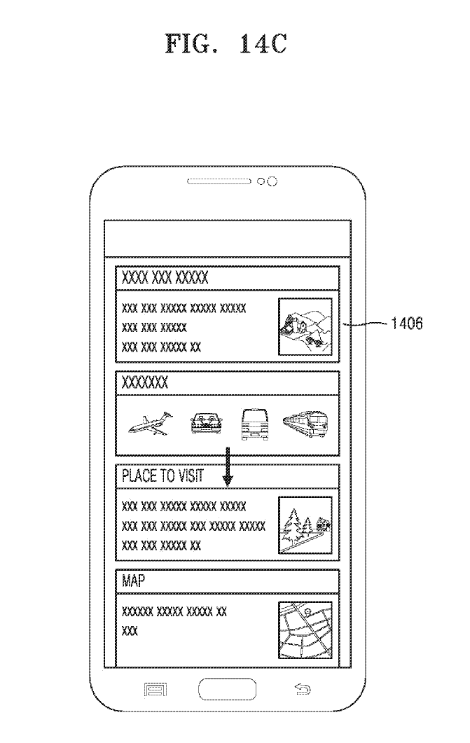

FIGS. 14A-14C illustrate an example scenario in which a second user interface, displaying additional information, is invoked on a user interface of a home screen, according to an embodiment.

In a scenario in which the user of the electronic device accesses the home screen displaying icons of a plurality of applications within the first user interface 1404, the proposed method can be used to provide the additional information (if any) of the plurality of applications without requiring the user to access each applications in order to retrieve the additional information (e.g., recent notifications, etc.) thereof.

The gesture detector 122 can be configured to detect the gesture input 1402 on the first user interface 1404 (as illustrated in FIG. 14A). In response to detecting the gesture input 1402, the electronic device determines the second level of information (i.e., additional information) of the plurality of applications based on the context of the icons of the plurality of applications displayed in the first user interface 1404. Further, the processor 140 can be configured to display the second level of information associated with plurality of applications in the second user interface 1406 (as illustrated in FIG. 7B-7C) in the form of corresponding widgets.

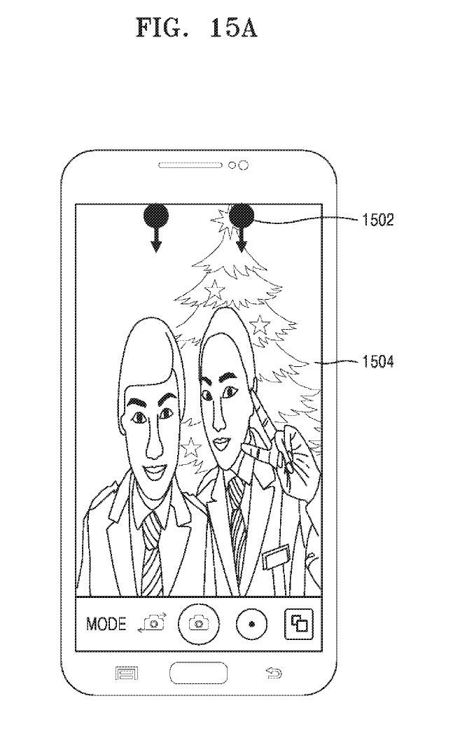

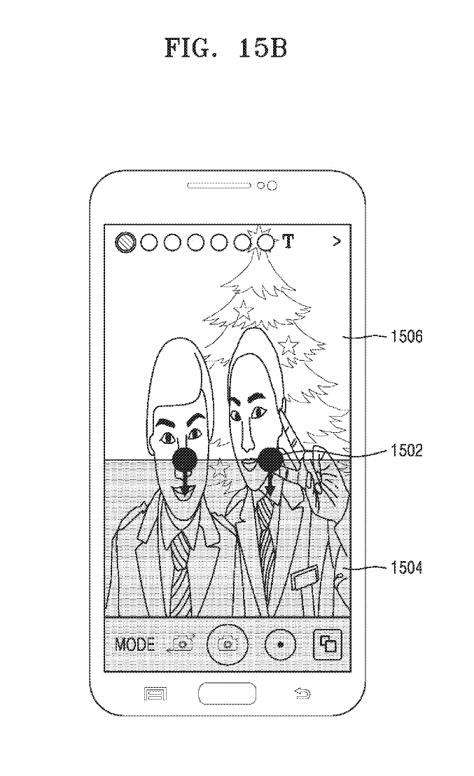

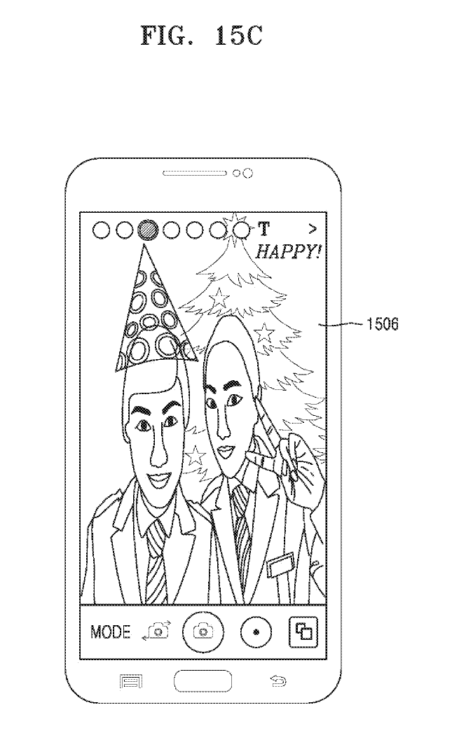

FIGS. 15A-15C illustrate an example scenario in which a second user interface, displaying additional information, within a user interface of a live camera is invoked, according to an embodiment.

In a scenario in which the user of the electronic device accesses the camera application in which a plurality of objects are displayed within the first user interface 1504, the proposed method allows the user to access the drawing tools within the camera application.

The gesture detector 122 can be configured to detect a gesture input 1502 on the first user interface 1504 (as illustrated in FIG. 15A). In response to detecting the gesture input 1502, the electronic device can be configured to invoke the second user interface 1506 (as illustrated in FIG. 15B). Further, the processor 140 can be configured to provide the drawing tools within the camera application in the second user interface 1506 (as illustrated in FIG. 15B-15C). The drawing tools allow the user to draw on a live camera mode of the camera application.

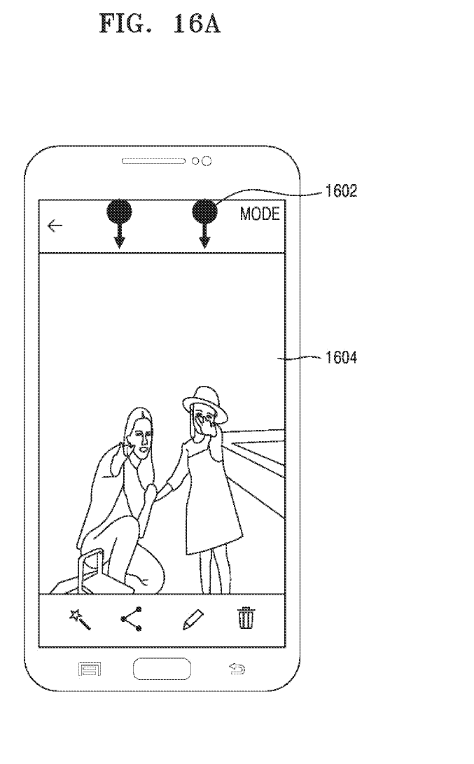

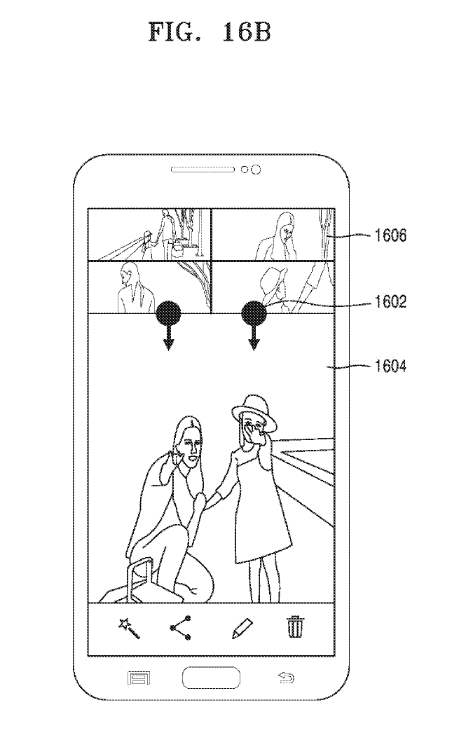

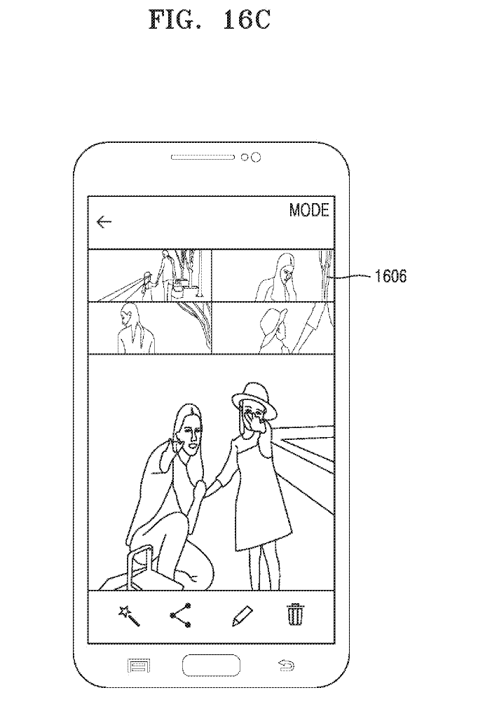

FIGS. 16A-16C illustrate an example scenario in which a second user interface, displaying images with a same context, is invoked on a user interface of a gallery application, according to an embodiment.

In a scenario in which the user of the electronic device accesses the gallery application displaying an image in the first user interface 1604, the proposed method can be used to identify and provide the images with the same context without requiring the user to browse for the images with the same context (e.g., all images with a sunset background are extracted and presented) thereof

The gesture detector 122 can be configured to detect the gesture input 1602 on the first user interface 1604 (as illustrated in FIG. 16A). In response to detecting the gesture input 1602, the electronic device determines the second level of information (i.e., images with the same context) of the image displayed in the first user interface 1604. Further, the processor 140 can be configured to display the second level of information associated with the image in the second user interface 1606 (as illustrated in FIG. 16B-16C).

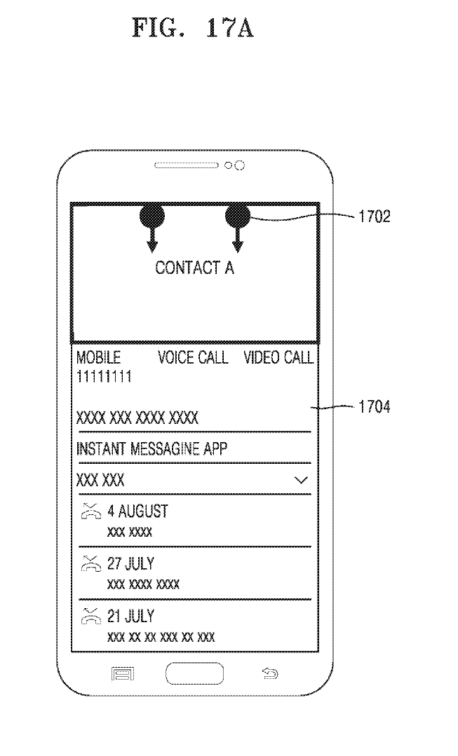

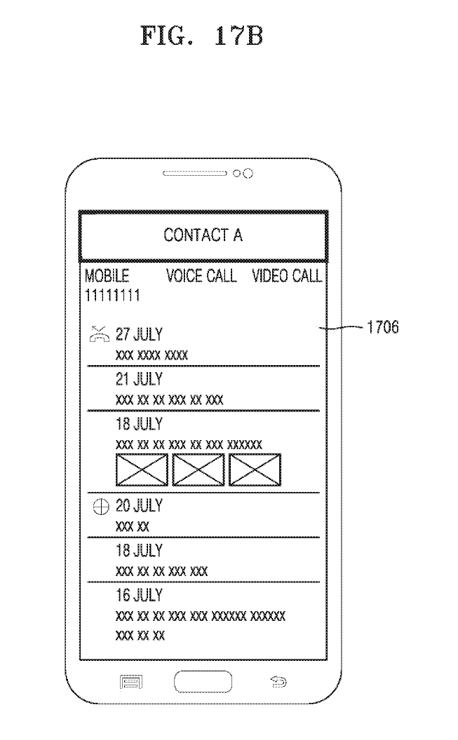

FIGS. 17A-17B illustrate an example scenario in which a second user interface, displaying additional information, is invoked on a user interface of a contact application, according to an embodiment.

In a scenario in which the user of the electronic device accesses the contact displaying details like call history, text messages, instant messages, image of the contact, etc., the proposed method can be used to identify and provide the additional information related to the contact without requiring the user to browse for the additional information on various applications (e.g., SNS data related to the user, messaging application status, etc.) thereof.

The gesture detector 122 can be configured to detect a gesture input 1702 on the first user interface 1704 (as illustrated in FIG. 17A). In response to detecting the gesture input 1702, the electronic device determines the second level of information (i.e., additional information) of the contact based on the context of the contact displayed in the first user interface 1704. Further, the processor 140 can be configured to display the second level of information associated with the contact in the second user interface 1706 (as illustrated in FIG. 17B).

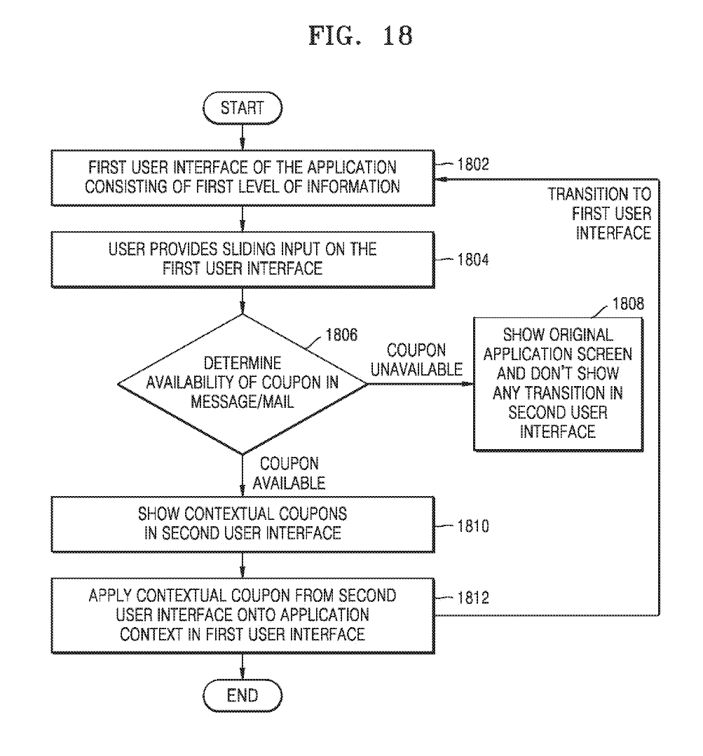

FIG. 18 is a flowchart illustrating a method of extracting and using contextual coupons in relevant applications, according to an embodiment.

Referring to FIG. 18, in operation 1802, the electronic device displays the first user interface of the application consisting of first level of information of the data item of the application. For example, in the electronic device as illustrated in the FIG. 3A, the display 180 can be configured to display the first user interface of the application consisting of first level of information of the data item of the application.

In operation 1804, the electronic device allows the user to provide a gesture input such as a sliding input on the first user interface. For example, in the electronic device as illustrated in the FIG. 3A, the gesture detector 122 can be configured to allow the user to provide sliding input on the first user interface.

In operation 1806, the electronic device determines the availability of coupons in messages and email application. For example, in the electronic device as illustrated in the FIG. 3A, the processor 140 can be configured to determine the availability of coupons in messages and email application.

In operation 1808, upon determining that the coupon is not available, the display 180 displays the original application screen and does not show any transition in the second user interface.

In operation 1810, upon determining that the coupon is available, the display 180 displays contextual coupons in the second user interface.

In operation 1812, the electronic device applies contextual coupon from the second user interface onto application context in the first user interface.

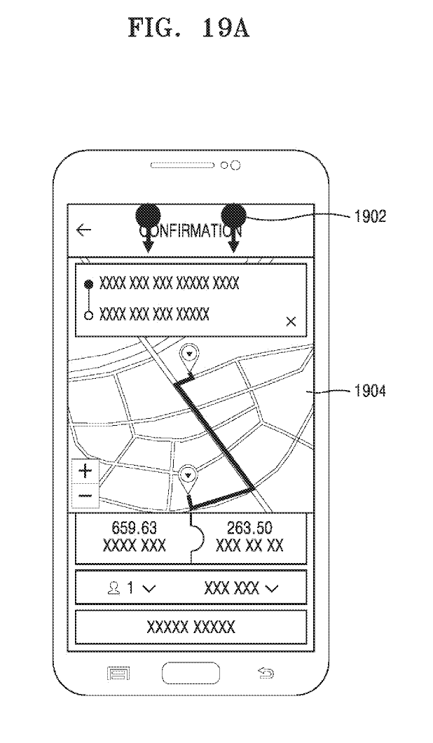

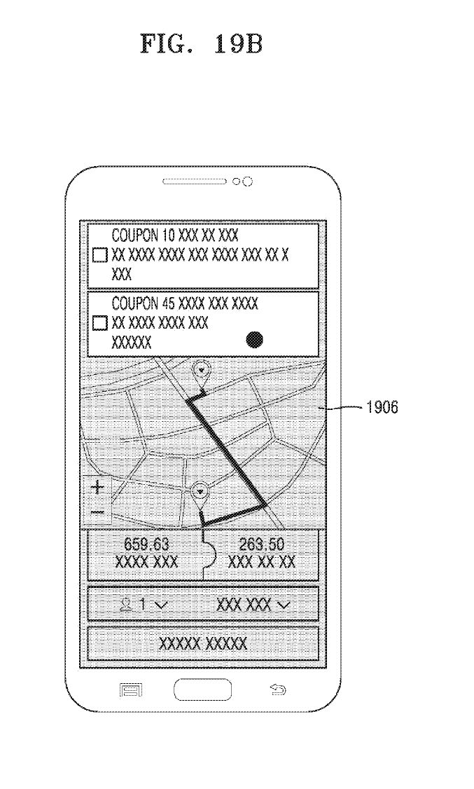

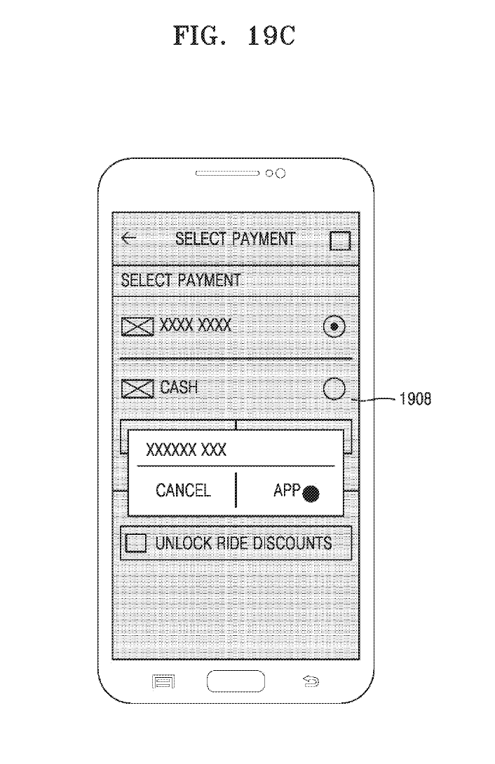

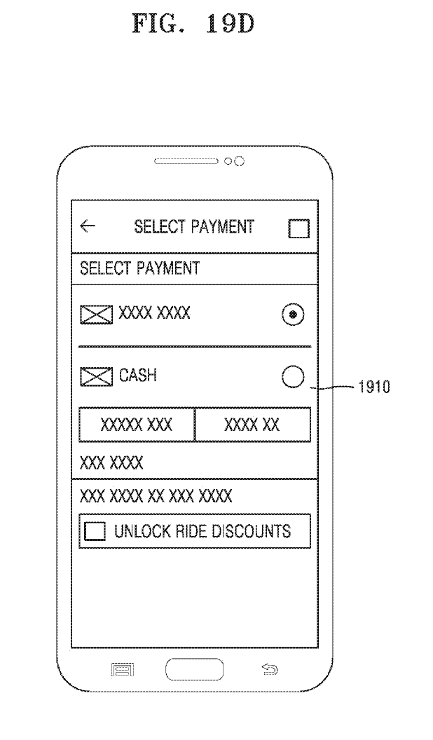

FIGS. 19A-19D illustrate an example scenario in which a second user interface, displaying contextual coupons, is invoked on a user interface of an advertisement application, according to an embodiment.

In a scenario in which the user of the electronic device accesses the cab application, the user enters the pickup and drop off locations, and confirms the trip in the first user interface 1904. The proposed method can be used to extract contextual coupons associated with the cab application and use it when the user makes the payment.

The gesture detector 122 can be configured to detect the gesture input 1902 on the first user interface 1904 (as illustrated in FIG. 19A). In response to detecting the gesture input 1902, the electronic device can be configured to invoke the second user interface 1906 (as illustrated in FIG. 19B). In one embodiment, the user will be able to define an area covered by the second user interface 1706 on the display screen of the electronic device. Further, the electronic device 100 identifies and displays the contextual coupons associated with the cab application from other applications in a second user interface 1906 (as illustrated in FIGS. 19B-19C). Further, the electronic device uses the contextual coupons when the user makes the payment, as illustrated in FIG. 19D.

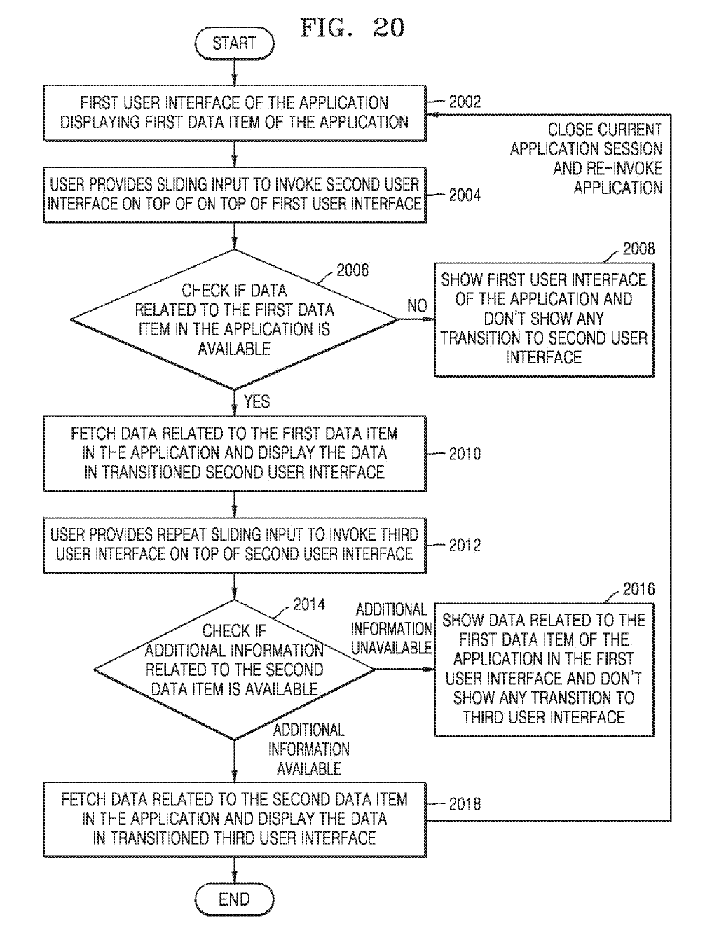

FIG. 20 is a flowchart illustrating a method of changing an existing view of an electronic device to display additional information related to a data item, according to an embodiment.

Referring to FIG. 20, in operation 2002, the electronic device displays the first user interface of the application displaying a first data item of the application. For example, in the electronic device as illustrated in the FIG. 3A, the display 180 can be configured to display the first user interface of the application displaying the first data item of the application.

In operation 2004, the electronic device allows the user to provide a gesture input to invoke the second user interface on top of the first user interface. For example, in the electronic device as illustrated in the FIG. 3A, the gesture detector 122 can be configured to allow the user to provide sliding input to invoke the second user interface on top of the first user interface.

In operation 2006, the electronic device checks whether data related to the first data item in the application is available. For example, in the electronic device as illustrated in the FIG. 3A, the processor 140 can be configured to check whether data related to the first data item in the application is available.

In operation 2008, upon determining that the data related to the first data item in the application is unavailable, the display 180 displays the first user interface of the application and does not display any transition to the second user interface.

In operation 2010, upon determining the data related to the first data item in the application is available, the processor 140 fetches the data related to the first data item in the application. Further, the display 180 displays the data related to the first data item in a transitioned second user interface.

In operation 2012, the electronic device, allows the user to provide a repeated gesture input to invoke a third user interface on top of the second user interface. For example, in the electronic device as illustrated in the FIG. 3A, the gesture detector 122 can be configured to allow the user to provide a repeated gesture input to invoke the third user interface on top of the second user interface.

In operation 2014, the electronic device checks whether additional information related to the second data item is available. For example, in the electronic device as illustrated in the FIG. 3A, the processor 140 can be configured to check whether additional information related to the second data item is available.

In operation 2016, upon determining that additional information related to the second data item is unavailable, the display 180 displays data related to the first data item of the application in the first user interface and does not display any transition to third user interface.

In operation 2018, upon determining that additional information related to the second data item is available, the processor 140 fetches the additional information related to the second data item. Further, the display 180 displays the additional information related to the second data item in a transitioned third user interface.

FIGS. 21A-21D illustrate an example scenario in which a second user interface, displaying additional information of objects, is invoked within a user interface of a live camera, according to an embodiment.

In a scenario in which the user of the electronic device accesses the camera application in which the view of the street is displayed within a first user interface 2104, the view of the street may display objects such as banks, stores, grocery shops, restaurants, etc. (as illustrated in FIG. 21A). The user of the electronic device may wish to view the details of the objects present in a field of view (FOV), and then the user may provide a gesture input 2102 on the first user interface 2104. In response to the gesture 2102, the electronic device automatically determines and displays the details of the objects in a second user interface 2108 (as illustrated in FIGS. 21B-21D). Thus providing an enhanced user experience by switching the normal camera view into at least one of AR view, panorama view, video mode, etc.

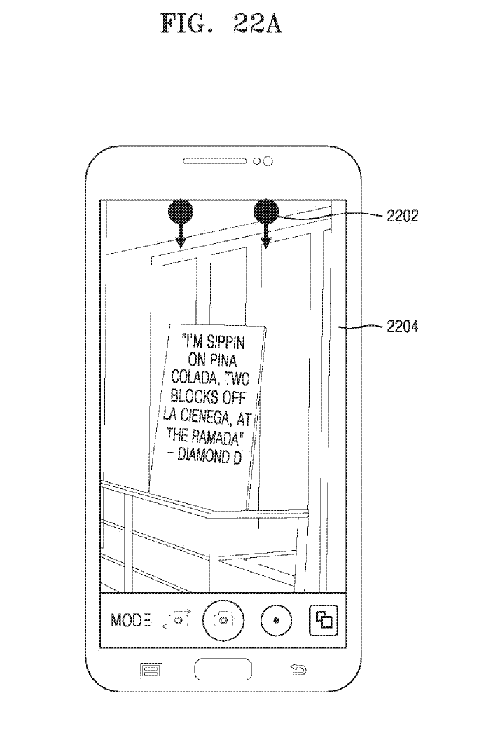

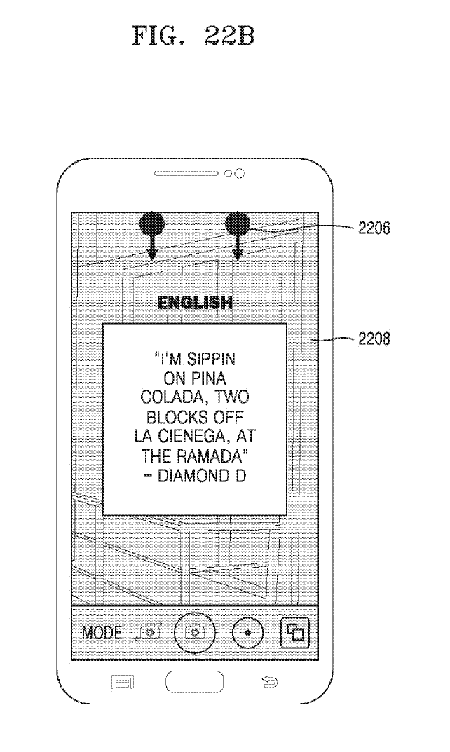

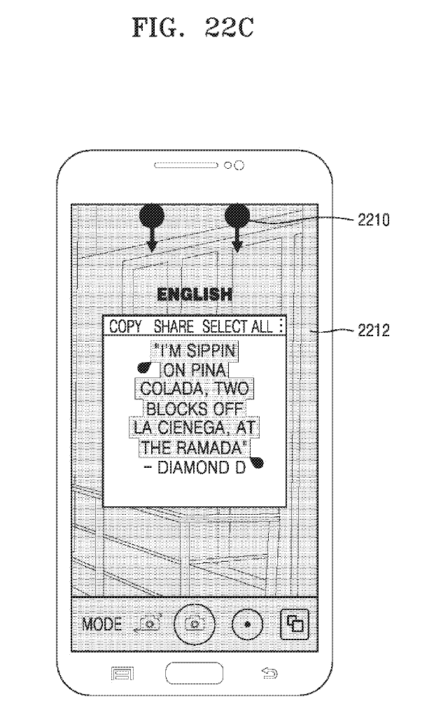

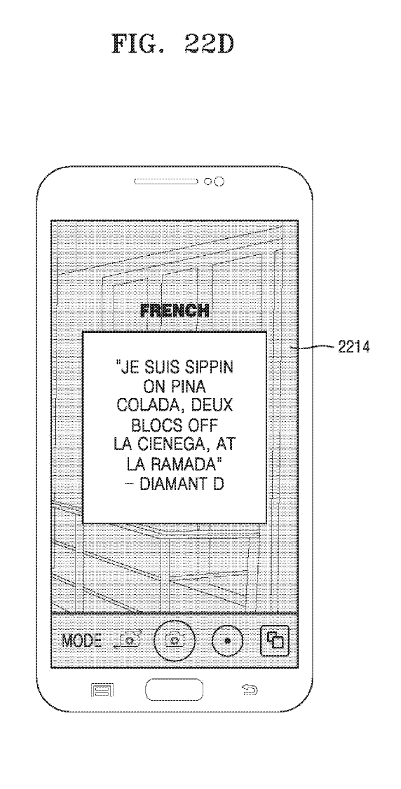

FIGS. 22A-22D illustrate another example scenario in which a second user interface, displaying additional information of an object, is invoked within a user interface of a live camera, according to an embodiment.

In a scenario in which the user of the electronic device accesses the camera application in which an object containing some text is displayed within a first user interface 2204, the user of the electronic device may wish to translate the text to another language, then according to the proposed method user may provide a gesture input 2202 on the first user interface 2204 (as illustrated in FIG. 22A).

In response to the gesture input 2202, the electronic device extracts the text and provides the text in an editable form in a second user interface 2212 (as illustrated in FIGS. 22B-22C). Further, the electronic device automatically translates the text and displays in an updated second user interface 2214 (as illustrated in FIGS. 22B-22D).

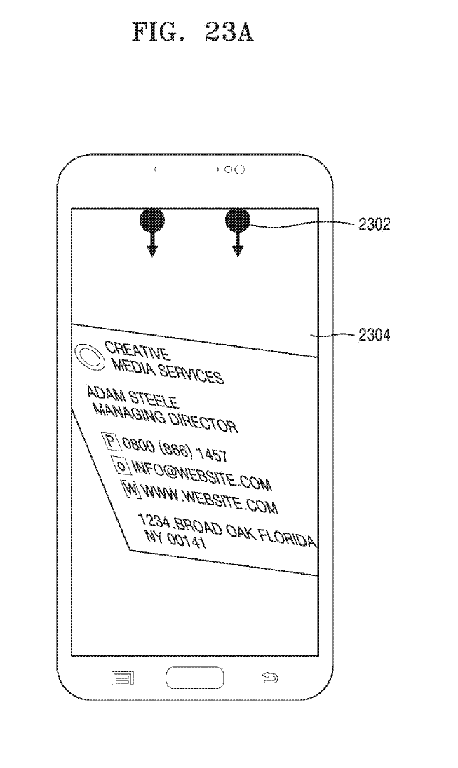

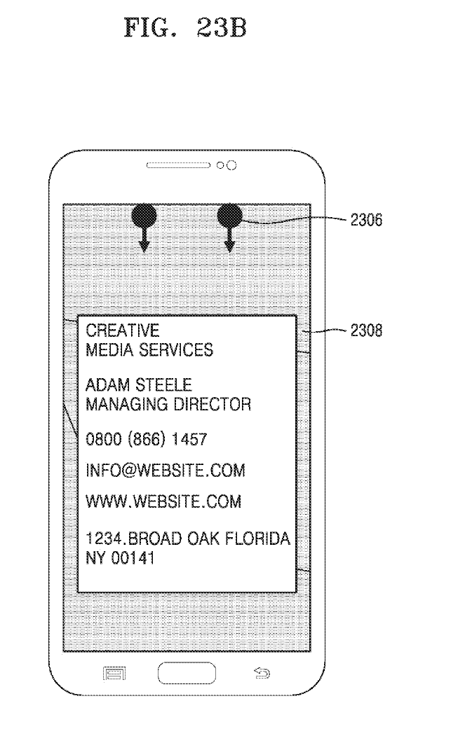

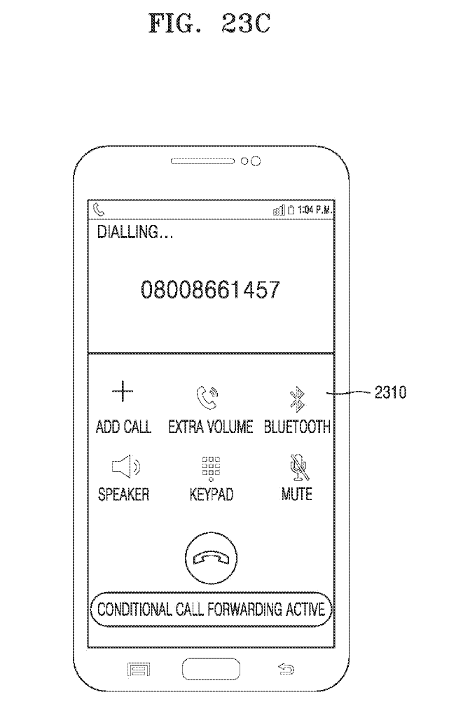

FIGS. 23A-23C illustrate an example scenario in which a second user interface, providing a call option, is invoked on a user interface of a gallery application, according to an embodiment.

In a scenario in which the user of the electronic device accesses the gallery application, the image in the gallery application includes an object containing some text. The proposed method can be used to extract information from the image and place the call with respect thereto.

The gesture detector 122 can be configured to detect the first gesture input 2302 on the first user interface 2304 (as illustrated in FIG. 23A). In response to detecting the first gesture input 2302, the electronic device can be configured to invoke the second user interface 2308 (as illustrated in FIG. 23B). In one embodiment, the user will be able to define an area covered by the second user interface 2308 on the display screen of the electronic device. Further, the processor 140 can be configured to extract information from the image and display the information from the image in the second user interface 2308 (as illustrated in FIG. 23B).

Further, the gesture detector 122 can be configured to detect the second gesture input 2306 on the second user interface 2308 (as illustrated in FIG. 23B). In response to detecting the second gesture input 2306, the electronic device can be configured to invoke the third user interface 2310. The processor 140 can be configured to facilitate the call option to the user in the third user interface 2310 (as illustrated in FIG. 23C).

FIGS. 24A-24D illustrate an example scenario in which a second user interface, displaying additional information related to a plurality of objects, is invoked within a user interface of a live camera, according to an embodiment.

In a scenario in which the user of the electronic device accesses the camera application, the live camera is the first user interface 2404. The field of view of the live camera includes a plurality of objects, e.g., a group of people, accessories, etc. The proposed method can be used to identify the emotions of the people in the group. Further, the proposed method can also be used to identify the objects and provide matching e-commerce information from various e-commerce applications thereof.

The gesture detector 122 can be configured to detect the first gesture input 2402 on the first user interface 2404 (as illustrated in FIG. 24A). In response to detecting the first gesture input 2402, the electronic device can be configured to invoke the second user interface 2408 (as illustrated in FIG. 24B). In one embodiment, the user will be able to define an area covered by the second user interface 2408 on the display screen of the electronic device. Further, the processor 140 can be configured to identify objects in the second user interface 2408 (as illustrated in FIG. 24B).

Further, the gesture detector 122 can be configured to detect the second gesture input 2406 on the second user interface 2408 (as illustrated in FIG. 24B).

In response to detecting the second gesture input 2406, the electronic device can be configured to invoke the third user interface 2412 (as illustrated in FIG. 24C). The processor 140 can be configured to identify the emotions of the people in the group (as illustrated in FIG. 24C).

Further, the gesture detector 122 can be configured to detect the third gesture input 2410 on the third user interface 2412 (as illustrated in FIG. 24C).

In response to detecting the third gesture input 2410, the electronic device can be configured to update the third user interface 2412 (as illustrated in FIG. 24D). The processor 140 can be configured to provide e-commerce information such as similar products, price details, etc., for the objects identified (e.g., clothes, accessories, etc.) from various e-commerce applications (as illustrated in FIG. 24D).

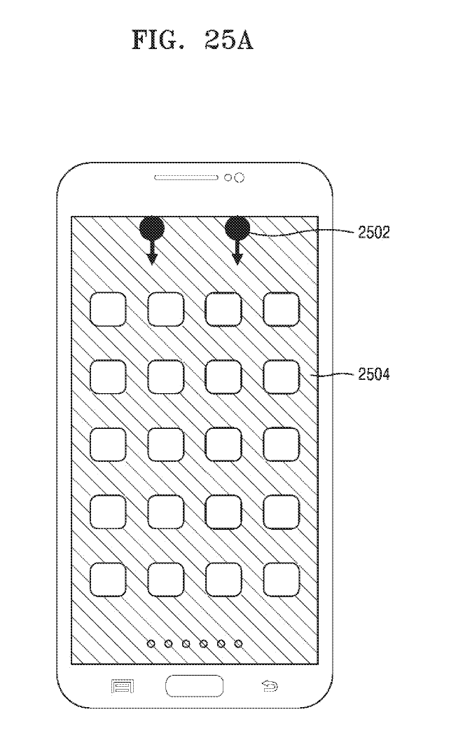

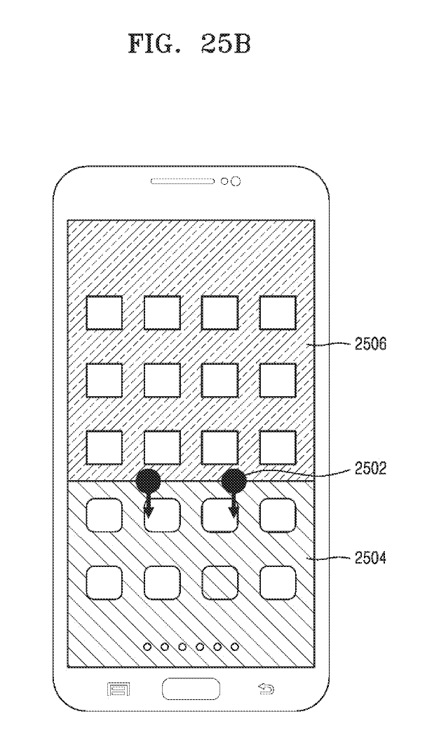

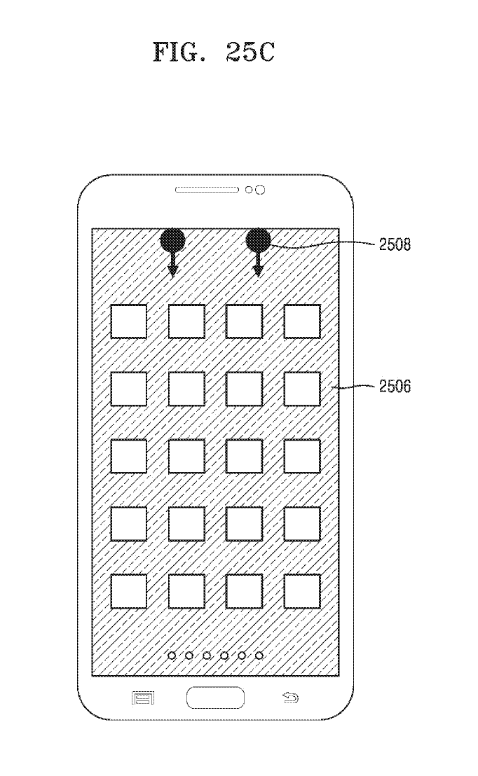

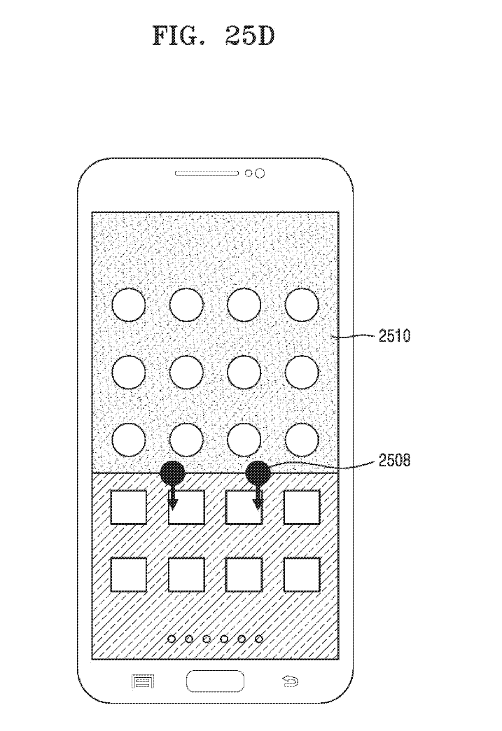

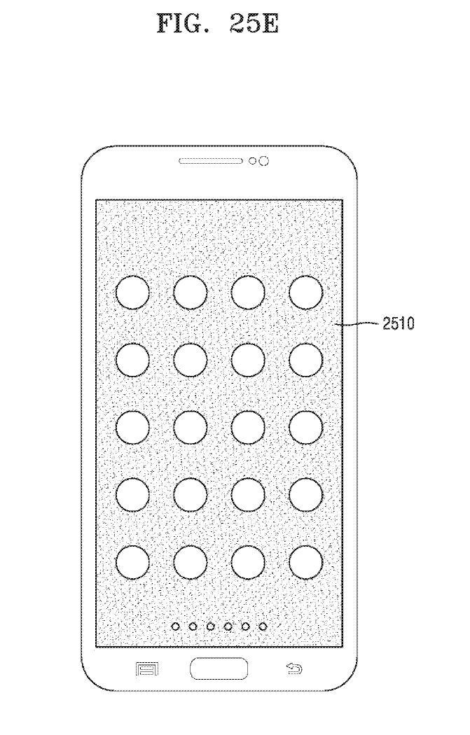

FIGS. 25A-25E illustrate an example scenario in which a second user interface, displaying a new wallpaper and/or theme is invoked on a user interface of a home screen, according to an embodiment.

In a scenario in which the user of the electronic device accesses the home screen, which is the first user interface 2504, the home screen has the wallpaper and the theme. The proposed method can be used to change the wallpaper and the theme by invoking the intelligent layer (i.e., second user interface) thereof.

The gesture detector 122 can be configured to detect the first gesture input 2502 on the first user interface 2504 (as illustrated in FIG. 25A). In response to detecting the first gesture input 2502, the electronic device can be configured to invoke the second user interface 2506 (as illustrated in FIG. 25B). In one embodiment, the user will be able to define an area covered by the second user interface 2506 on the display screen of the electronic device. The processor 140 can be configured to change the wallpaper/theme in the second user interface 2506 (as illustrated in FIG. 25B).

Further, the gesture detector 122 can be configured to detect the second gesture input 2508 on the second user interface 2506 (as illustrated in FIG. 25C).

In response to detecting the second gesture input 2508, the electronic device can be configured to invoke the third user interface 2510 (as illustrated in FIG. 25D). The processor 140 can be configured to provide the next wallpaper/theme in the third user interface 2510 (as illustrated in FIGS. 25D-25E).

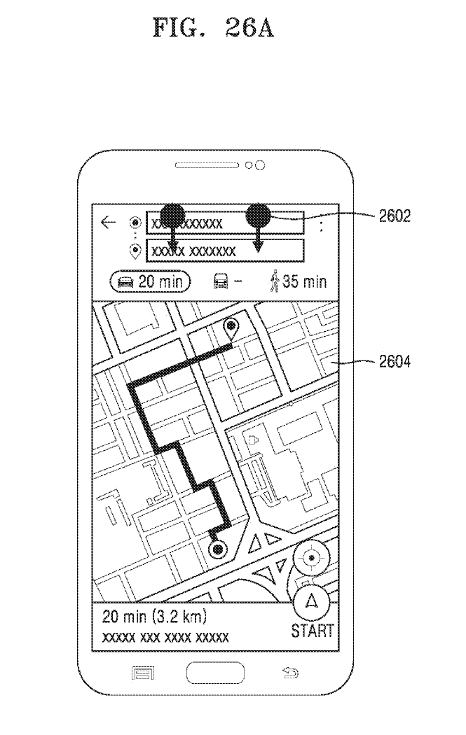

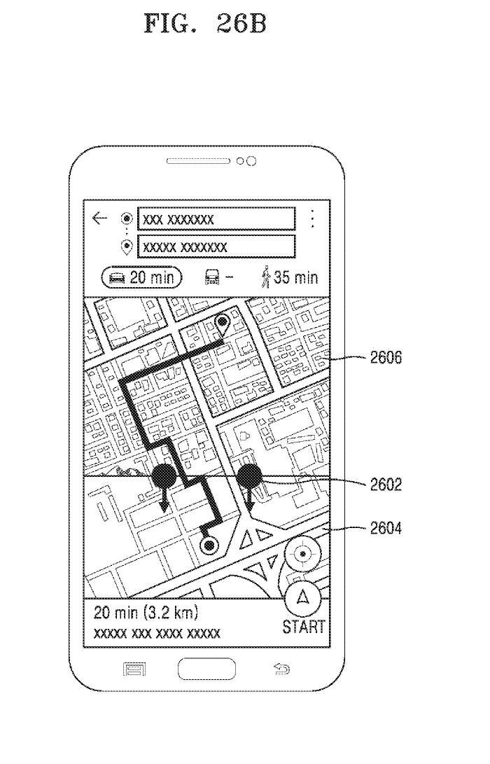

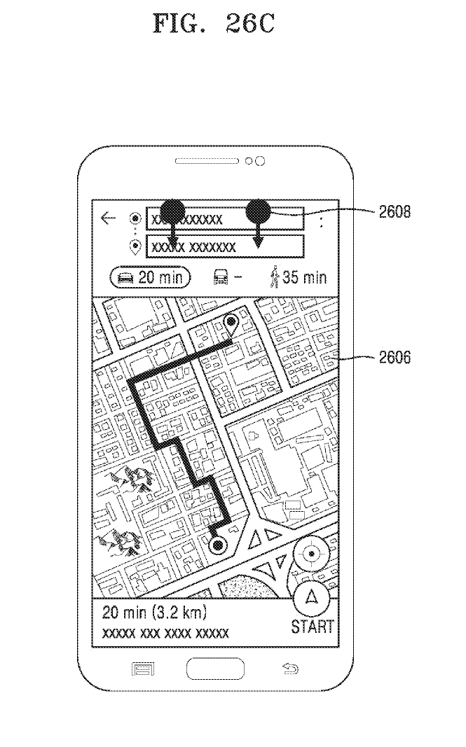

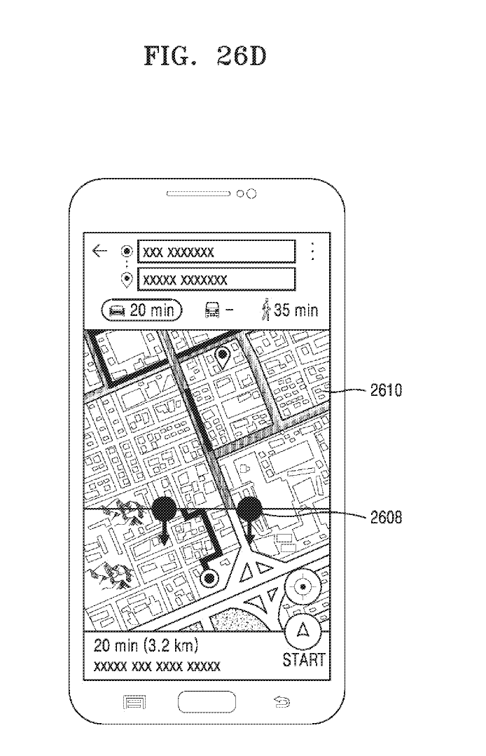

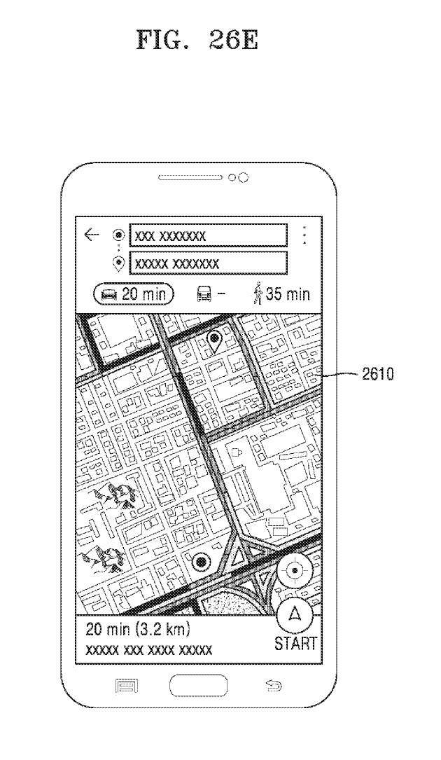

FIGS. 26A-26E illustrate an example scenario in which a second user interface, displaying additional information, is invoked on a user interface of a map application, according to an embodiment.

In a scenario in which the user of the electronic device accesses the map application displaying a location map in a map view, the location map in the map view is displayed in the first user interface 2604. The proposed method can be used to identify and provide the additional information (if any) related to the location in a suitable mode (e.g., satellite mode, 3D mode, etc.) thereof.

The gesture detector 122 can be configured to detect the first gesture input 2602 on the first user interface 2604 (as illustrated in FIG. 26A). In response to detecting the first gesture input 2602, the electronic device can be configured to invoke the second user interface 2606 (as illustrated in FIG. 26B). In one embodiment, the user will be able to define an area covered by the second user interface 2606 on the display screen of the electronic device. The processor 140 can be configured to identify and display the additional information (if any) related to the location in the suitable mode (e.g., satellite mode, 3D mode, etc.,) (as illustrated in FIGS. 26B and 26C).

Further, the gesture detector 122 can be configured to detect the second gesture input 2608 on the second user interface 2606 (as illustrated in FIG. 26C). In response to detecting the second gesture input 2608, the electronic device can be configured to invoke the third user interface 2610 (as illustrated in FIG. 26C). The processor 140 can be configured to identify and provide additional information related to the location searched by the user such as highlighting of traffic information, etc. (as illustrated in FIG. 26D).

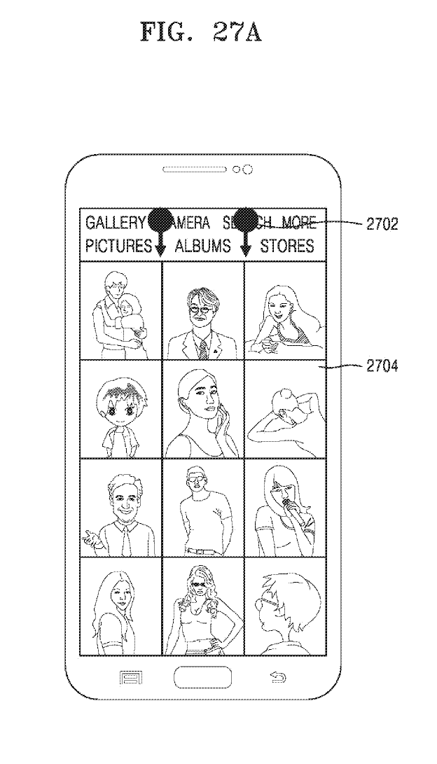

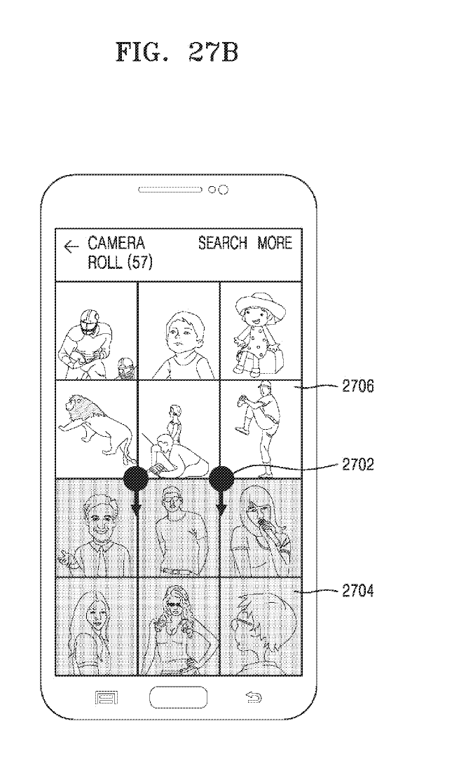

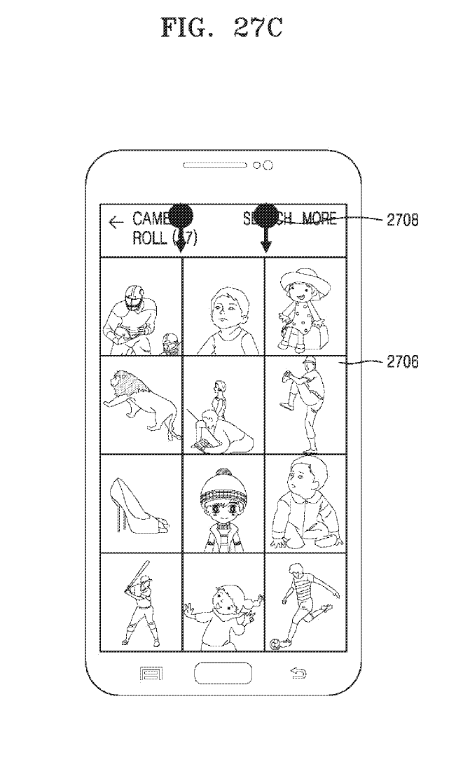

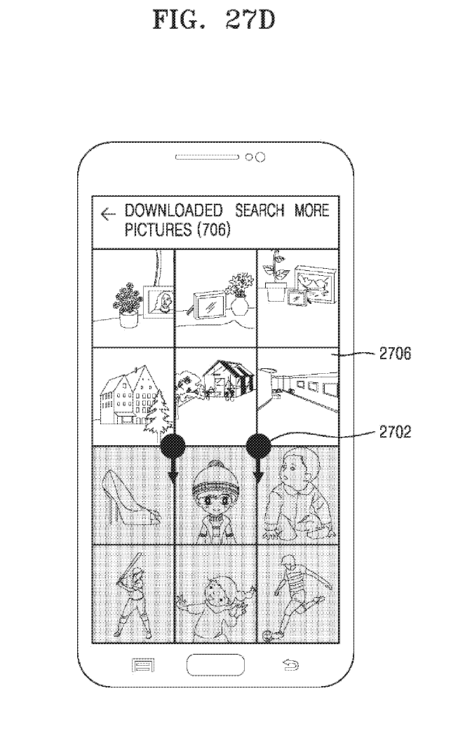

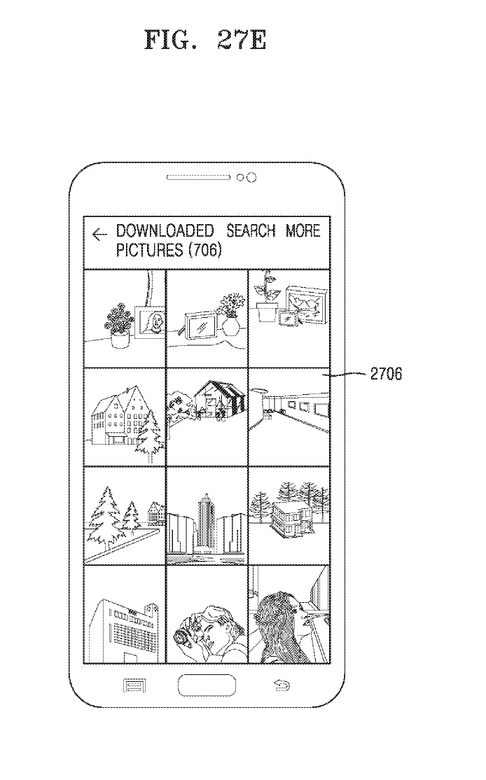

FIGS. 27A-27E illustrate an example scenario in which a second user interface, displaying a different gallery folder, is invoked on a user interface of a gallery application, according to an embodiment.

In a scenario in which the user of the electronic device accesses the gallery application displaying a plurality of images, the plurality of images are displayed in the first user interface 2704. The plurality of images are categorized into various image folders (e.g., camera roll, saved images, downloaded images, screen shot images, received images, images from instant messaging applications, etc.).

The gesture detector 122 can be configured to detect the first gesture input 2702 on the first user interface 2704 (as illustrated in FIG. 27A).

In response to detecting the first gesture input 2702, the electronic device can be configured to invoke the second user interface 2706 (as illustrated in FIG. 27B). In one embodiment, the user will be able to define an area covered by the second user interface 2706 on the display screen of the electronic device.

The processor 140 can be configured to navigate from one image folder to the other image folder (e.g., from gallery folder to the camera roll folder) (as illustrated in FIGS. 27B and 27C).

Further, the gesture detector 122 can be configured to detect the second gesture input 2708 on the second user interface 2706 (as illustrated in FIG. 27C).

In response to detecting the second gesture input 2708, the electronic device can be configured to invoke the updated second user interface 2706 (as illustrated in FIG. 27C). The processor 140 can be configured to further navigate from one image folder to the other image folder (e.g., from camera roll folder to the downloaded images folder) (as illustrated in FIGS. 27C and 27D).

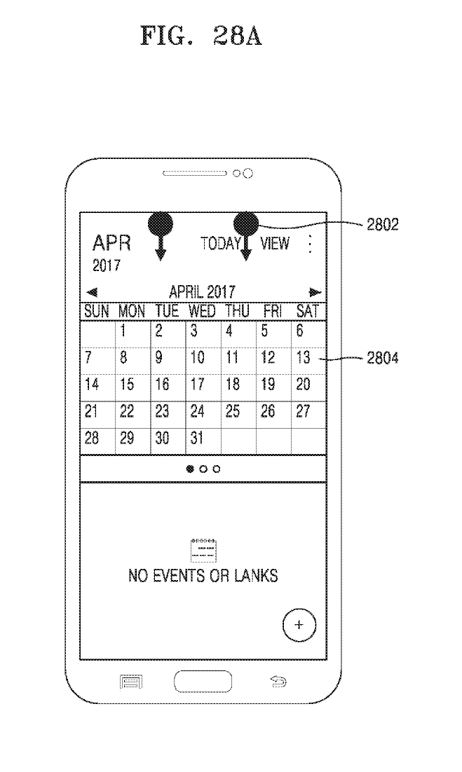

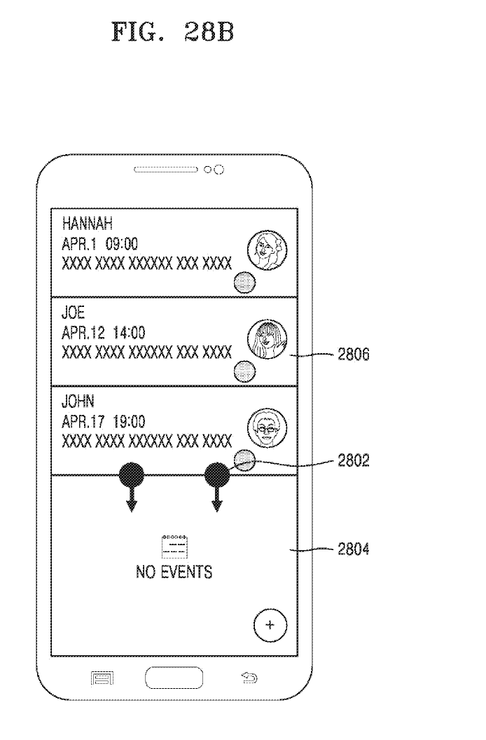

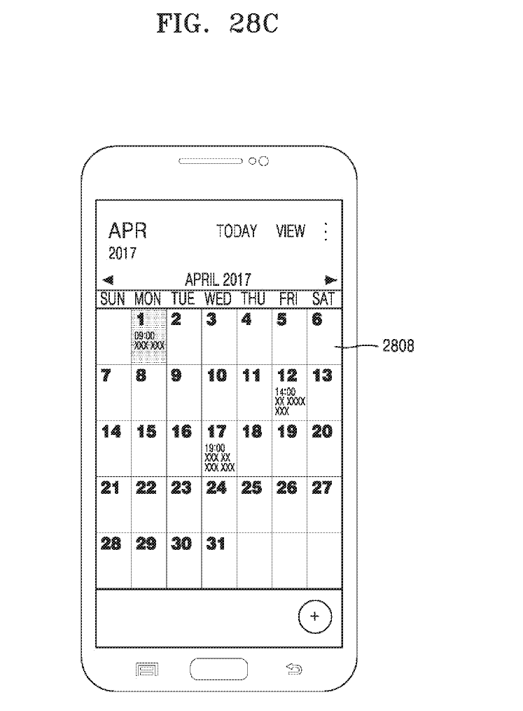

FIGS. 28A-28C illustrate an example scenario in which a second user interface, displaying additional information, is invoked on a user interface of a calendar application, according to an embodiment.

In a scenario in which the user of the electronic device accesses the calendar application, the first user interface 2804 provides a calendar with a list of tasks and reminders for each date (if any). The proposed method can be used to extract information related to an appointment, a meeting, an event based notification, etc., and add the information to the calendar thereof.

The gesture detector 122 can be configured to detect the first gesture input 2802 on the first user interface 2804 (as illustrated in FIG. 28A).

In response to detecting the first gesture input 2802, the electronic device determines information related to appointments, meetings, events, etc., from messages/emails. Further, the processor 140 can be configured to add the information related to the appointment, the meeting, the event based notification, etc., to the calendar and display it in the third user interface 2808 (as illustrated in FIG. 28C).

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers of ordinary skill in the art to which the present disclosure pertains.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

While the present disclosure has been particularly shown and described with reference to certain embodiments thereof, it will be understood by those of ordinary skill in the art that various changes in form and details may be made therein without departing from the spirit and scope of the present disclosure as defined by the following claims and their equivalents.

What is claimed is:

1. A method of managing information of an application in an electronic device, the method comprising:
controlling to display a first user interface of the application on a screen of the electronic device, wherein the first user interface displays one or more of a first level of information of at least one data item of the application and at least one first data item of the application;
detecting a first gesture input performed on the first user interface;
determining a second level of information of the at least one data item based on a context of the at least one data item displayed in the first user interface; and
displaying a second user interface comprising the second level of information of the at least one data item on the screen of the electronic device.

2. The method of claim 1, wherein determining the second level of information is performed when the first user interface displays the first level of information of the at least one data item of the application, and
wherein the method further comprises:
detecting a second gesture input performed on the second user interface;
determining a third level of information of the at least one data item based on a context of the at least one data item displayed in the second user interface; and
updating the second user interface to display the third level of information along with additional information of the at least one data item of the application on the screen of the electronic device.

3. The method of claim 2, wherein the second user interface is associated with the electronic device and is not a user interface of the application.

4. The method of claim 2, wherein the second level of information comprises additional information about the at least one data item, and
wherein the additional information is displayed using at least one of an augment reality, a widget, a symbol, or a sub-user interface.

5. The method of claim 2, wherein the second user interface is displayed in a translucent manner.

6. The method of claim 2, wherein information of the data items of the application dynamically changes in the second user interface based on the context each time a slide input is received.

7. The method of claim 1, further comprising:
determining, when the first user interface displays the at least one first data item of the application, at least one second data item based on the context of the at least one data item displayed in the first user interface; and
controlling to display the second user interface comprising the at least one second data item of the application on the screen of the electronic device.

8. The method of claim 7, wherein the at least one second data item of the application dynamically changes based on a context each time a slide input is received.

9. The method of claim 2, wherein a direction of the first gesture input is different from a direction of the second gesture input.

10. The method of claim 2, wherein the first gesture input and the second gesture input are slide inputs.

11. The method of claim 2, wherein the first gesture input is different from the second gesture input.

12. An electronic device for managing information of an application, the electronic device comprising:
a memory storing the application; and
a processor coupled to the memory, and configured to:
control displaying of a first user interface of the application on a screen of the electronic device, wherein the first user interface displays one or more of a first level of information of at least one data item of the application and at least one first data item of the application,
detect a gesture input performed on the first user interface,
determine a second level of information of the at least one data item based on a context of the at least one data item displayed in the first user interface, and
control displaying of a second user interface comprising the second level of information of the at least one data item on the screen of the electronic device.

13. The electronic device of claim 12, wherein the processor is further configured to:
determine the second level of information, when the first user interface displays the first level of information of the at least one data item of the application;
detect a second gesture input performed on the second user interface;
determine a third level of information of the at least one data item based on a context of the at least one data item displayed in the second user interface; and
update the second user interface to display the third level of information along with additional information of the at least one data item of the application on the screen of the electronic device.

14. The electronic device of claim 13, wherein the second user interface is associated with the electronic device and is not a user interface of the application.

15. The electronic device of claim 13, wherein the second level of information comprises additional information about the at least one data item, and
wherein the additional information is displayed using at least one of an augment reality, a widget, a symbol, or a sub-user interface.

16. The electronic device of claim 13, wherein the second user interface is displayed in a translucent manner.

17. The electronic device of claim 13, wherein information of the data items of the application dynamically changes in the second user interface based on the context each time a slide input is received.

18. The electronic device of claim 12, wherein the processor is further configured to:
determine, when the first user interface is controlled to display the at least one first data item of the application, at least one second data item based on the context of the at least one data item displayed in the first user interface, and
control displaying of the second user interface comprising the at least one second data item of the application on the screen of the electronic device.

19. The electronic device of claim 18, wherein the at least one second data item of the application dynamically changes based on a context each time a slide input is received.

20. A non-transitory computer readable recording medium having recorded thereon a program for executing a method of managing information of an application in an electronic device, the method comprising:
displaying a first user interface of the application on a screen of the electronic device, wherein the first user interface displays one or more of a first level of information of at least one data item of the application and at least one first data item of the application;
detecting a first gesture input performed on the first user interface;
determining a second level of information of the at least one data item based on a context of the at least one data item displayed in the first user interface; and
displaying a second user interface comprising the second level of information of the at least one data item on the screen of the electronic device.
